(19) United States
(12) Patent Application Publication
(10) Pub. No.: US 2005/0022109 A1
(43) Pub. Date: Jan. 27, 2005

(54) Document display apparatus

(75) Inventors: Koichi Sakai, Nagoya (JP); Kenji Matsunaga, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 10/919,352

(22) Filed: Aug. 17, 2004

Related U.S. Application Data
(63) Continuation of application No. PCT/JP02/01821, filed on Feb. 27, 2002.

(51) Int. Cl. G06F 17/00

(52) U.S. Cl. 715/500

(57) ABSTRACT

The purpose of the present invention is to enable display of a screen of a document so as to clearly indicate that a script is under execution while maintaining easiness to see the screen of the document. A document display unit displays the contents of a document which is inputted, in a first manner of display. Next, a processing execution unit executes processing in accordance with a description of processing. Then, a manner-of-display change unit changes the manner of display of the contents of the document to a second manner of display after the processing is completed.

This application is a continuing application, filed under 35 U.S.C. § 111(a) of International Application PCT/JP02/01821, filed Feb. 27, 2002.

### BACKGROUND OF THE INVENTION

(1) Field of the Invention

The present invention relates to a document display apparatus for displaying a document containing descriptions of processing, and in particular to a document display apparatus which indicates that processing according to the descriptions is under execution.

(2) Description of the Related Art

With the recent widespread use of the Internet, increase in functions relating to display of HTML (Hyper Text Markup Language) documents have been required. In one of known techniques for increasing functions relating to display of HTML documents, a program embedded in an HTML document is executed by a client computer, which executes a web browser (which is hereinafter referred to as a browser). Generally, programs embedded in HTML documents are written in simple programming languages called script languages.

For example, JavaScript is one of the script languages which enable embedding in HTML documents, where Java is a registered trademark. When a client computer receives an HTML document in which JavaScript is embedded, the client computer executes processing in accordance with a script. That is, when a predetermined script is embedded in an HTML document, it is possible to make a client computer execute predetermined processing.

When a script is embedded in an HTML document, a browser cannot receive a manipulation input until execution of the script is completed. When a user makes a manipulation input into a browser screen by mistake during execution of a script by the browser, a script error occurs. In addition, when execution of a script is not normally completed due to a manipulation input into a browser screen during the execution of the script, in some cases, it is impossible to make a subsequent manipulation input into the browser screen. Therefore, conventionally, the progress of execution of a script is displayed on the screen in order to notify the user that the script is under execution.

FIG. 30 is a diagram illustrating a first example of a conventional manner of display of the progress of execution of a script. In the first example, when an HTML document in which a script is embedded is downloaded into a client computer, a processing-progress dialog box 911 is displayed over a browser screen 910. In the processing-progress dialog box 911, the progress of execution of the script is indicated. In the example of FIG. 30, the processing-progress dialog box 911 indicates “execution progress: 80%.” In addition, the processing-progress dialog box 911 has a cancel button 912. When the cancel button 912 is pressed, the client computer stops the execution of the script.

FIG. 31 is a diagram illustrating a second example of a conventional manner of display of the progress of execution of a script. In the second example, when an HTML document in which a script is embedded is downloaded into a client computer, and execution of the script is completed, a notification-of-completion dialog box 921 is displayed over a browser screen 920. In the notification-of-completion dialog box 921, a message indicating completion of the execution of the script is displayed. In the example of FIG. 31, the notification-of-completion dialog box 921 indicates “Execution is completed.” In addition, the notification-of-completion dialog box 921 has an OK button 922. When the OK button 922 is pressed, the notification-of-completion dialog box 921 is closed, and the browser screen 920 is activated.

FIG. 32 is a diagram illustrating a third example of a conventional manner of display of the progress of execution of a script. In the third example, when an HTML document in which a script is embedded is downloaded into a client computer, a status bar 931 is displayed at the bottom of a browser screen 930. The status bar 931 is an indicator which indicates the progress of execution of the script. When the execution of the script is completed, a message indicating completion of the execution of the script is displayed in the browser screen 930.

As explained above, the progress of execution of a script can be displayed in various manners. When the progress of execution is displayed in one of the various manners, it is possible to notify a user of the progress of execution of the script.

However, when a notification of the progress of execution of a script is made in the conventional manners, the browser screen is uneasy to see during execution of the script, or the state in which the execution of the script is under execution is uneasy to recognize.

For example, in the first example illustrated in FIG. 30, the processing-progress dialog box 911 is displayed over the browser screen 910 during execution of the script. Therefore, the user cannot see the entire web page indicated on the browser screen 910.

In the second example illustrated in FIG. 31, only the browser screen 920 is displayed during execution of the script, and the notification-of-completion dialog box 921 is not displayed until the execution of the script is completed. Therefore, the user cannot recognize that the script is under execution. In addition, when the notification-of-completion dialog box 921 indicating the progress of execution of a script is displayed, the user is forced to press the OK button 922. That is, the user is bothered with a useless operation.

In the third example illustrated in FIG. 32, the notification-of-completion dialog box 921 indicating the progress of execution of a script is displayed at the bottom of the browser screen 930, and the size of the status bar 931 is small. Therefore, the status bar 931 is uneasy to find.

When a portion of the webpage cannot be seen even after completion of download of an HTML document, the user cannot browse the contents of the HTML document until the execution of the script is completed. This is very inconvenient for the user who merely wishes to refer to the contents of the webpage in order to confirm whether or not the webpage contains desired information.

On the other hand, when the state in which the script is under execution is not clearly indicated, the user is likely to make a manipulation input by error during the execution of the script, and therefore the operations of the browser or other functions become unstable. Thus, the reliability decreases from the viewpoint of stable operation of the entire system.

### SUMMARY OF THE INVENTION

The present invention is made in view of the above problems, and the object of the present invention is to provide a document display apparatus which can clearly indicate that a state in which a script is under execution, while maintaining easiness to see a document screen.

In order to solve the aforementioned problem, a document display apparatus as illustrated in FIG. 1 is provided. The document display apparatus according to the present invention displays on a screen a document 1 containing a description of processing 1a. The document display apparatus according to the present invention comprises: a document display means 2 which displays the contents 1b of the document 1 in a first manner of display 5 when the document 1 is inputted; a processing execution means 3 which executes processing in accordance with the description of processing 1a contained in the document 1 when the contents 1b of the document 1 is displayed by the document display means 2; and a manner-of-display change means 4 which changes the manner of display of the contents 1b of the document 1 to a second manner of display 6 when execution of the processing by the processing execution means 3 in accordance with the description of processing 1a is completed.

In the above document display apparatus, first, the document display means 2 displays the contents 1b of the inputted document 1 in the first manner of display 5. Next, the processing execution means 3 executes the processing in accordance with the description of processing 1a. After completion of the processing, the manner-of-display change means 4 changes the manner of display of the contents 1b of the document 1 to the second manner of display 6.

In addition, in order to solve the aforementioned problem, a document-embedded type program which is described in a document is provided. The document-embedded type program according to the present invention is characterized in making a computer execute processing which comprises: a step of displaying the contents of the document in a first manner of display when the document is inputted; a step of executing processing in accordance with a description of essential processing contained in the document, after the step of displaying the contents is executed; and a step of changing the manner of display of the contents of the document to a second manner of display in accordance with a description of processing for changing the manner of display, which is also contained in the document, when execution of the processing in accordance with the description of essential processing is completed.

When the above document-embedded type program is executed by a computer, the aforementioned document display apparatus according to the present invention is realized by the computer.

Further, in order to solve the aforementioned problem, a document display method for displaying on a screen a document containing a description of processing is provided. The document display method according to the present invention is characterized in comprising: a step of displaying the contents of the document in a first manner of display when the document is inputted; a step of executing processing in accordance with the description of processing contained in the document when the contents of the document is displayed; and a step of changing the manner of display of the contents of the document to a second manner of display when execution of the processing in accordance with the description of processing is completed.

According to the above document display method, first, the contents of the inputted document are displayed in the first manner of display. Thereafter, when the contents of the inputted document are displayed, the processing is executed in accordance with the description of processing. After completion of the processing, the manner of display of the contents of the document is changed to the second manner of display.

Furthermore, in order to solve the aforementioned problem, a computer-readable recording medium which stores a document-embedded type program which is described in a document is provided. The document-embedded type program is characterized in making a computer execute processing comprising: a step of displaying the contents of the document in a first manner of display when the document is inputted; a step of executing processing in accordance with the description of essential processing contained in the document, after the step of displaying the contents is executed; and a step of changing the manner of display of the contents of the document to a second manner of display in accordance with a description of processing for changing the manner of display, which is also contained in the document, when execution of the processing in accordance with the description of essential processing is completed.

When the above document-embedded type program stored in the computer-readable recording medium is executed by a computer, the aforementioned document display apparatus according to the present invention is realized by the computer.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a conceptual diagram illustrating the present invention which is realized in an embodiment.

FIG. 2 is a diagram illustrating an example of a construction of a system of the embodiment.

FIG. 3 is a diagram illustrating an example of a hardware construction of a client computer used in the embodiment.

FIG. 4 is a function block diagram illustrating functions of the client computer and a server computer.

FIG. 5 is a diagram illustrating a first example of an HTML document in the case where a background color is changed.

FIG. 6 is a flow diagram of a first example of processing for changing a background color.

FIG. 7 is a diagram illustrating a first example of an HTML document in the case where a background color is changed.

FIG. 8 is a diagram illustrating an example of display of a webpage during execution of a script in the case where a background color is changed.

FIG. 9 is a diagram illustrating an example of display of a webpage after completion of execution of a script in the case where a background color is changed.

FIG. 10 is a diagram illustrating a second example of an HTML document in the case where a background color is changed.

FIG. 11 is a flow diagram of a second example of processing for changing a background color.

FIG. 12 is a diagram illustrating a second example of an HTML document in the case where a background color is changed.

FIG. 13 is a diagram illustrating a first example of an HTML document in the case where a text color is changed.

FIG. 14 is a diagram illustrating a first example of an HTML document in the case where a text color is changed.

FIG. 15 is a diagram illustrating an example of display of a webpage during execution of a script in the case where a text color is changed.

FIG. 16 is a diagram illustrating a second example of an HTML document in the case where a text color is changed.

FIG. 17 is a diagram illustrating a second example of an HTML document in the case where a text color is changed.

FIG. 18 is a diagram illustrating a first example of an HTML document in the case where a background color and a text color are changed.

FIG. 19 is a diagram illustrating a first example of an HTML document in the case where a background color and a text color are changed.

FIG. 20 is a diagram illustrating an example of display of a webpage during execution of a script in the case where a background color and a text color are changed.

FIG. 21 is a diagram illustrating a second example of an HTML document in the case where a background color and a text color are changed.

FIG. 22 is a diagram illustrating a second example of an HTML document in the case where a background color and a text color are changed.

FIG. 23 is a diagram illustrating an example of a construction of a system in the case where images are changed.

FIG. 24 is a diagram illustrating a first example of an HTML document in the case where images are changed.

FIG. 25 is a diagram illustrating a first example of an HTML document in the case where images are changed.

FIG. 26 is a diagram illustrating an example of display of a webpage during execution of a script in the case where images are changed.

FIG. 27 is a diagram illustrating an example of display of a webpage after completion of execution of a script in the case where images are changed.

FIG. 28 is a diagram illustrating a second example of an HTML document in the case where images are changed.

FIG. 29 is a diagram illustrating a second example of an HTML document in the case where images are changed.

FIG. 30 is a diagram illustrating a first example of a conventional manner of display of the progress of execution of a script.

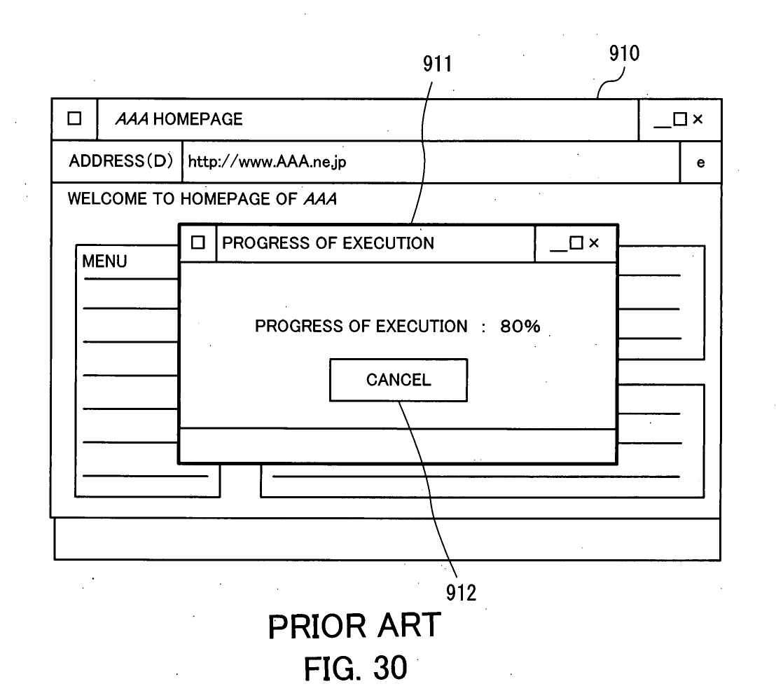

FIG. 31 is a diagram illustrating a second example of a conventional manner of display of the progress of execution of a script.

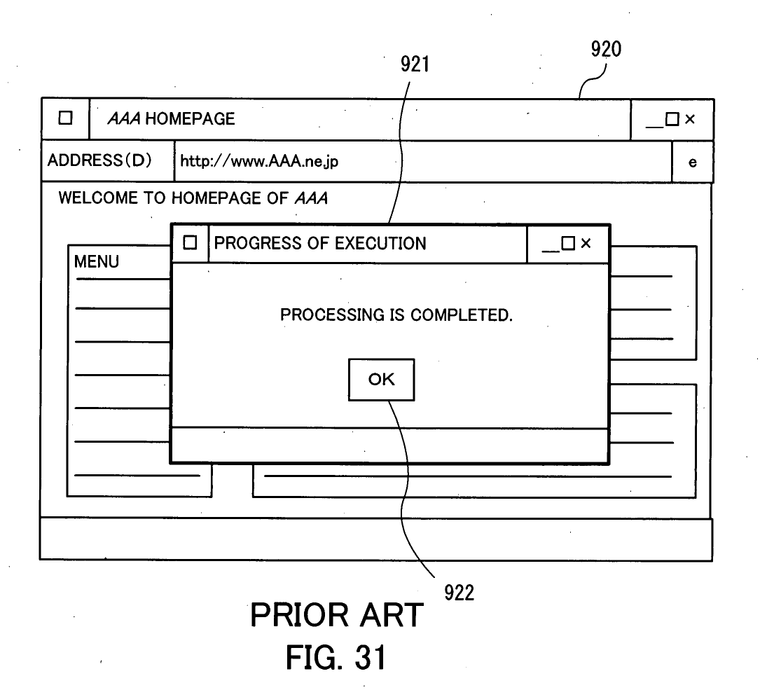

FIG. 32 is a diagram illustrating a third example of a conventional manner of display of the progress of execution of a script.

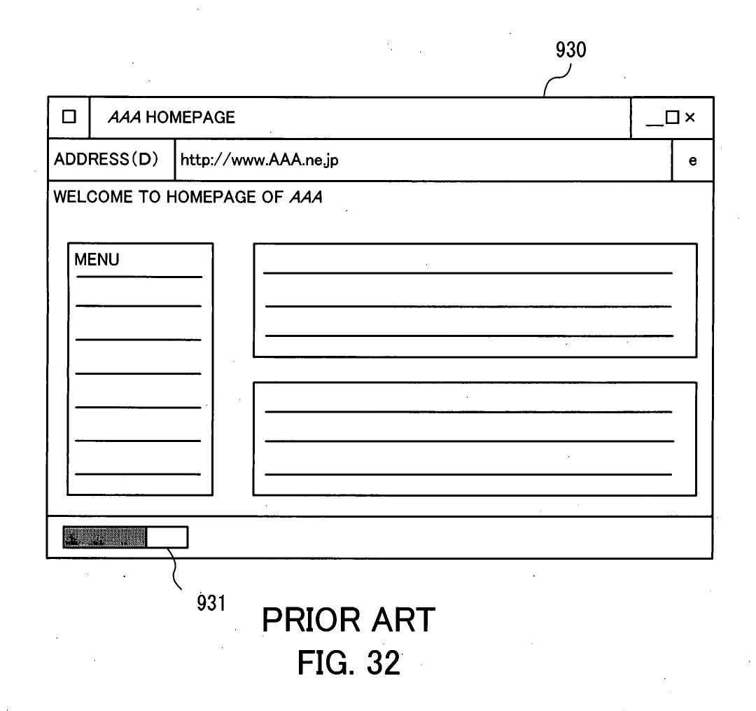

### DESCRIPTION OF THE PREFERRED EMBODIMENTS

An embodiment of the present invention is explained below with reference to drawings.

First, an outline of the present invention which is realized in the embodiment is explained, and thereafter details of the embodiment are explained.

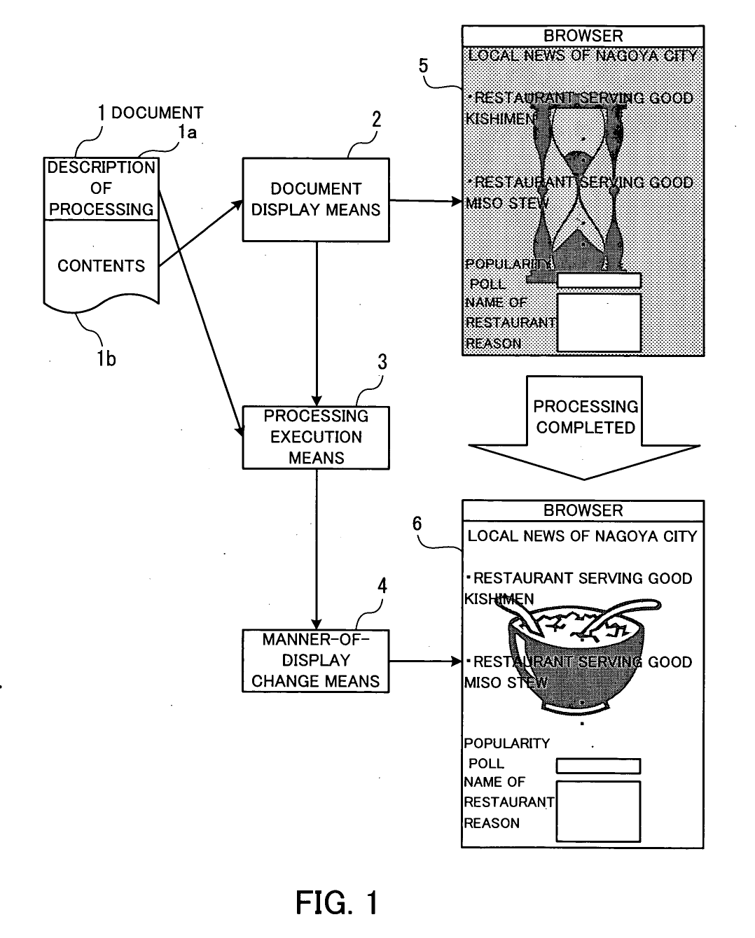

FIG. 1 is a conceptual diagram illustrating the present invention which is realized in an embodiment. The document display apparatus according to the present invention comprises a document display means 2, a processing execution means 3, and a manner-of-display change means 4.

The document display means 2 displays the contents 1b of the document 1 in a first manner of display 5 when a document 1 containing a description of processing 1a is inputted. The first manner of display 5 is a manner of display for indicating that processing in accordance with the description of processing 1a is under execution. In the first manner of display 5, for example, the background color is gray, characters are displayed in gray, or a monochrome image is displayed in the background. In the example of FIG. 1, a monochrome image of a sandglass is displayed in the background.

The processing execution means 3 executes processing in accordance with the description of processing 1a contained in the document 1 when the contents 1b of the document 1 are displayed by the document display means 2. For example, the processing execution means 3 executes processing for initializing the environment by executing predetermined processing in response to a user's manipulation input.

The manner-of-display change means 4 changes the manner of display of the contents 1b of the document 1 to a second manner of display 6 when the execution of the processing by the processing execution means 3 in accordance with the description of processing 1a is completed. The second manner of display 6 is a manner of display for indicating that processing in accordance with the description of processing 1a is completed. In the second manner of display 6, for example, the background color is white, characters are displayed in black, or a color image is displayed in the background. In the example of FIG. 1, a color image of a china bowl is displayed as a background image for local news.

In the above document display apparatus, first, the document display means 2 displays the contents 1b of the inputted document 1 in the first manner of display 5. Next, the processing execution means 3 executes the processing in accordance with the description of processing 1a. After completion of the processing, the manner-of-display change means 4 changes the manner of display of the contents 1b of the document 1 to the second manner of display 6.

That is, the contents 1b of the document 1 are displayed in the first manner of display 5 during execution of processing in accordance with description of processing 1a. In addition, since all of the contents 1b of the document 1 are displayed without being hidden behind a dialog box or the like, the user can browse all of the contents 1b without waiting for completion of the processing in accordance with the description of processing 1a. Further, since the screen is displayed in the first manner of display 5, the user can easily recognize that the processing in accordance with the description of processing 1a is under execution. Therefore, it is possible to prevent the user from performing an inappropriate operation during execution of the processing in accordance with the description of processing 1a.

Furthermore, since the manner of display is changed to the second manner of display 6 after completion of the processing in accordance with the description of processing 1a, the user can recognize that the processing is completed, and manipulation input is allowed.

Incidentally, it is possible to define in the document 1 the first and second manners of display 5 and 6 of the contents 1b of the document 1. In this case, first, the document display apparatus which loads the document 1 displays the contents 1b in the first manner of display 5, which is defined in the document 1. Thereafter, when execution of the processing in accordance with the description of processing 1a is completed, the document display apparatus displays the contents 1b in the second manner of display 6, which is also defined in the document 1.

In the above case where the manners of display are defined in the document 1, a provider of the document 1 (e.g., a server computer) can set appropriate manners of display for each document 1 according to the contents 1b of the document 1. For example, when gray characters are used in a portion of the contents 1b, it is possible to make the contents 1b easier to see by making the background color black. At this time, it is also possible to notify, in advance, the user of a manner of display used as the first manner of display 5. For example, it is possible to indicate explanations on the manner of display on the main screen of the website during execution of a script.

Moreover, the document display apparatus according to the present invention can be realized in a client computer which acquires content through the Internet, and displays the content. Hereinbelow, an embodiment of the present invention is explained in detail by taking as an example a case where the present invention is applied to delivery of an HTML document through the Internet.

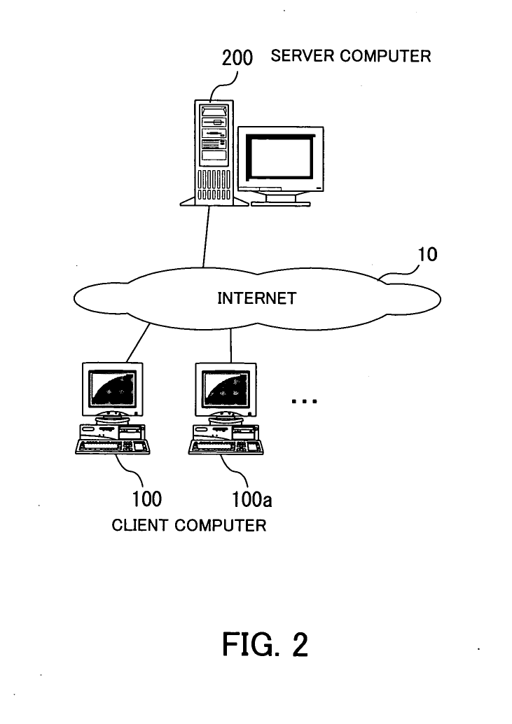

FIG. 2 is a diagram illustrating an example of a construction of a system of the embodiment. In the present invention, a plurality of client computers 100, 100a, . . . are connected to a server computer 200 through the Internet 10. The user can browse HTML documents stored in the server computer 200 by manipulating the client computers 100, 100a, . . . .

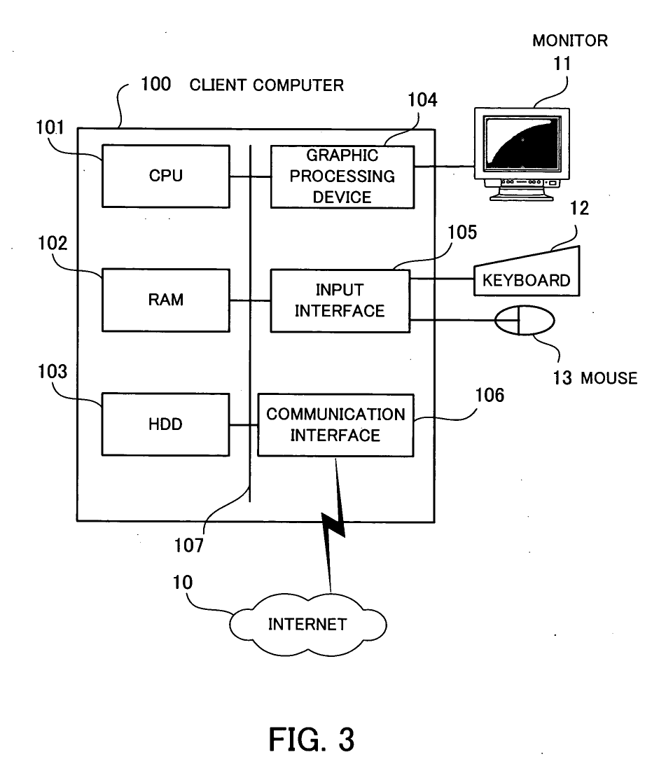

FIG. 3 is a diagram illustrating an example of a hardware construction of a client computer used in the embodiment. The entire system of the client computer 100 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least a portion of an OS (operating system) program and application programs which are executed by the CPU 101, as well as various types of data which are necessary for the CPU 101 to perform processing. The HDD 103 stores the OS program and the application programs.

A monitor 11 is connected to the graphic processing device 104, which makes the monitor 11 display an image on an screen in accordance with an instruction from the CPU 101. A keyboard 12 and a mouse 13 are connected to the input interface 105, which transmits signals transmitted from the keyboard 12 and the mouse 13, to the CPU 101 through the bus 107.

The communication interface 106 is connected to the Internet 10. The communication interface 106 is provided for exchanging data with other computers through the Internet 10.

By using the above hardware construction, it is possible to realize the processing functions in the present embodiment. In addition, each of the other client computers 100a, . . . and the server computer 200 can also be realized by a similar hardware construction.

Next, the processing functions of the client computer 100 and the server computer 200 are explained below.

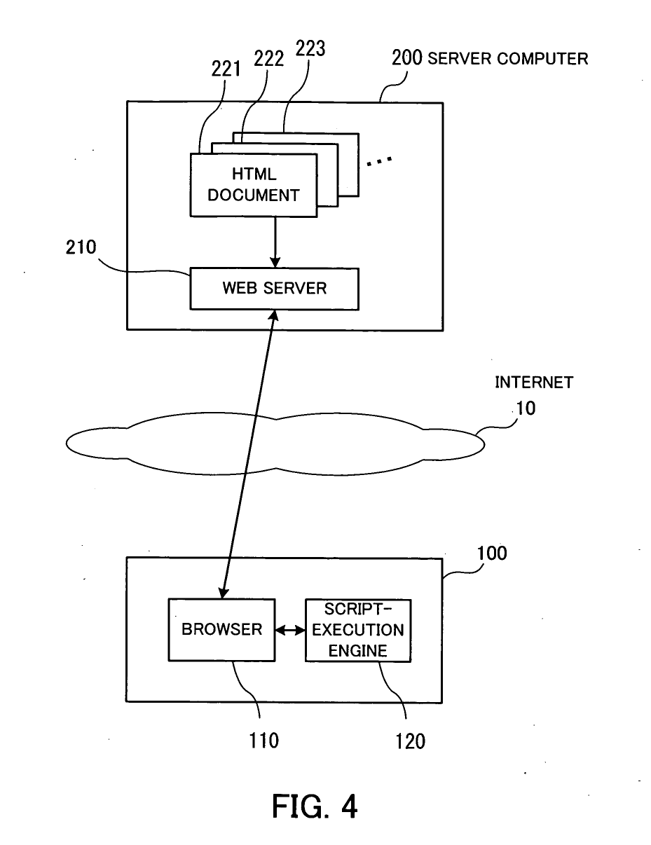

FIG. 4 is a function block diagram illustrating the functions of the client computer and the server computer. The server computer 200 comprises a web server 210 and a plurality of HTML documents 221, 222, 223, . . . . The web server 210 transmits the HTML documents 221, 222, 223, . . . to the client computer 100 in response to requests from the client computer 100. The HTML documents 221, 222, 223, . . . are document files the structures of which are defined in HTML. The HTML documents 221, 222, 223, . . . can contain descriptions of processing as a script.

The client computer 100 comprises a browser 110 and a script-execution engine 120.

In response to a user's manipulation input, the browser 110 transmits to the server computer 200 a request for acquisition of an HTML document. When an HTML document is sent from the server computer 200, the browser 110 interprets definitions of manners of display which are written in the HTML document, and displays the contents of the HTML document on the screen. In addition, when the acquired HTML document contains a script, the browser 110 passes the script to the script-execution engine 120.

The script-execution engine 120 operates in association with the browser 110. The script-execution engine 120 interprets descriptions in the script passed from the browser 110, into a machine language on a line-by-line basis, and executes the script.

According to the network system having the above construction, it is possible to make the client computers 100, 100a, . . . which acquire the HTML documents execute arbitrary processing, by inserting descriptions of processing as a script in each HTML document stored in the server computer 200. Therefore, according to the present embodiment, operations of displaying each HTML document during execution of a script and after completion of the execution of the script are described in a script contained in the HTML document.

Incidentally, the following display methods can be considered in order to clearly display an execution progress of a script.

(1) The background color displayed during execution of a script is differentiated from the background color displayed after completion of the execution of the script. That is, the background color is changed. In this case, the background color displayed during execution of a script is set to a special color by which the user can easily recognize that the execution has not yet progressed to a state in which manipulation input is allowed. For example, the background color displayed during execution of a script is set to gray. In many recent software packages, unselectable commands among commands in a pull-down menu are grayed out (i.e., indicated in gray). Therefore, when the background is displayed in gay in the present embodiment, the user can easily recognize the state in which manipulation input is not allowed.

(2) The text color displayed during execution of a script is differentiated from the text color displayed after completion of the execution of the script. That is, the text color is changed. In this case, the text color displayed during execution of a script is set to a special color by which the user can easily recognize that the execution has not yet progressed to a state in which manipulation input is allowed. For example, the text color displayed during execution of a script is set to gray. That is, the grayed-out display, which has been used in the pull-down menus and the like, is used. Therefore, when the text is displayed in gay in the present embodiment, the user can easily recognize the state in which manipulation input is not allowed.

(3) The background color and the text color displayed during execution of a script are differentiated from the background color and the text color displayed after completion of the execution of the script, respectively. That is, both of the background color and the text color are changed. When the background and the text are displayed in gay in the present embodiment, the user can easily recognize the state in which manipulation input is not allowed.

(4) An image displayed during execution of a script is differentiated from an image displayed after completion of the execution of the script. That is, an image is changed. In this case, an image by which the user can easily recognize that the execution has not yet progressed to a state in which manipulation input is allowed is displayed during execution. For example, a monochrome image is displayed during execution of a script. The image indicating the progress of execution of a script may be an image which is displayed in a conspicuous position (e.g., near a title) in a webpage or a background image Hereinbelow, details of processing for each of the above four display methods are explained.

[In The Case Where Background Color Is Changed]

For example, it is possible to differentiate the background color displayed during execution of a script from the background color displayed after completion of the execution of the script, in the following two ways.

In the first way, a background color which is to be displayed during execution of a script is defined in advance in a portion of the contents of an HTML document. Thereafter, when initialization in accordance with the script is completed, the background color is changed to a background color which is to be displayed after completion of the execution of the script.

In the second way, the background color which is to be displayed during execution of a script is set when initialization in accordance with the script is started. Thereafter, when the initialization in accordance with the script is completed, the background color is changed to a background color which is to be displayed after completion of the execution of the script.

The first way of changing the background color is explained below.

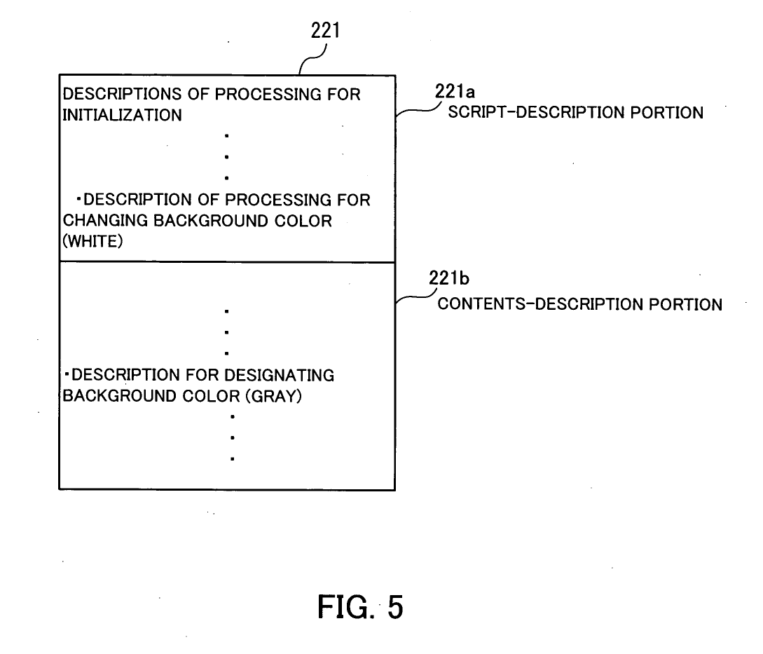

FIG. 5 is a diagram illustrating a first example of an HTML document in the case where the background color is changed. As illustrated in FIG. 5, the HTML document 221 can contain a script-description portion 221a and a contents-description portion 221b. The script-description portion 221a includes descriptions of processing for initialization. The descriptions of processing for initialization constitute a script which is executed when a download of the HTML document 221 is completed and a screen based on the contents-description portion 221b is displayed. The descriptions of processing for initialization include a description of processing for changing the background color as a description of processing in the final stage. In the example of FIG. 5, processing for changing the background color to white is described.

The contents-description portion 221b is a portion in which the contents of the document to be displayed are defined in HTML. The contents-description portion 221b includes a description for designating a background color. In the example of FIG. 5, gray is designated as the background color.

When the client computer 100 acquires from the server computer 200 the HTML document 221 having the contents illustrated in FIG. 5, the browser 110 and the script-execution engine 120 operate in association with each other so as to perform processing for displaying the document.

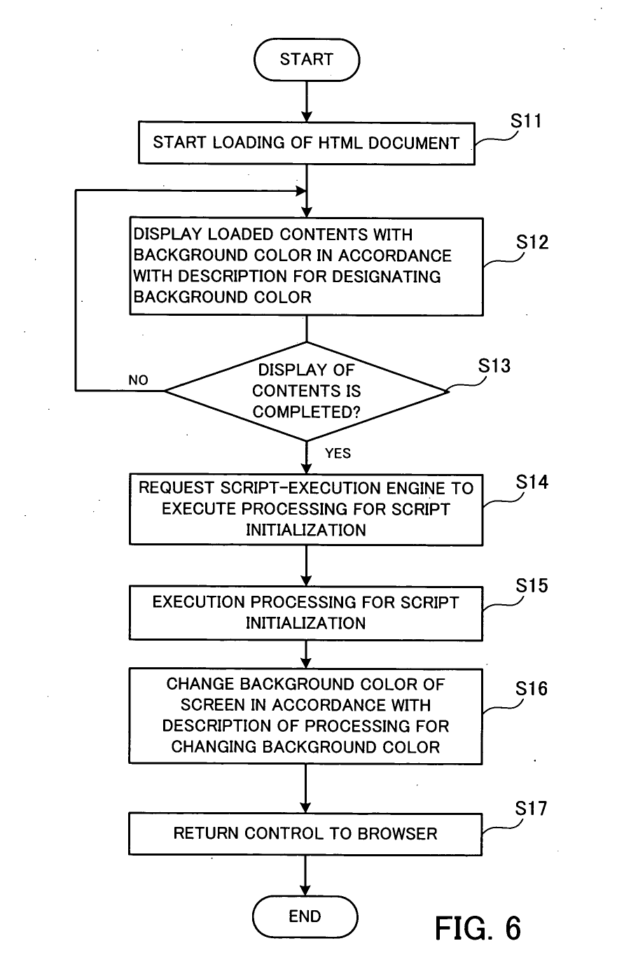

FIG. 6 is a flow diagram of a first example of processing for changing the background color. When the client computer 100 outputs to the server computer 200 a browsing request for the HTML document 221, and the HTML document 221 is sent from the server computer 200 to the client computer 100, the processing of FIG. 6 is started. The processing illustrated in FIG. 6 is explained below step by step.

[Step S12] The browser 110 starts an operation of loading the HTML document 221.

[Step S12] The browser 110 displays the contents of the HTML document 221 which are defined in the contents-description portion 221b of the HTML document 221 loaded as above, in such a manner that the background color is in accordance with the aforementioned description for designating a background color, which is included in the contents-description portion 221b. Since gray is designated as the background color in the example of FIG. 5, the contents of the document are displayed over the gray background.

[Step S13] The browser 110 determines whether or not the operation of displaying the contents is completed. When no is determined, the operation goes to step S12, and the operation of displaying the contents is continued. When yes is determined, the operation goes to step S14. When the operation of displaying the contents is completed, a status indication of the browser 110 (which is realized by, for example, an icon or a status bar located at an upper right area) indicates a state in which the operation of loading the HTML document 221 is completed. [Step S14] The browser 110 passes to the script-execution engine 120 information on the script-description portion 221a of the HTML document 221, and requests the script-execution engine 120 to execute the processing for initialization in accordance with the script.

[Step S15] The script-execution engine 120 executes the processing for initialization in accordance with (a portion essential to the initialization of) the script described in the script-description portion 221a.

[Step S16] When the execution of the portion of the script-description portion 221a essential to the initialization is completed, the script-execution engine 120 changes the background color of the screen in accordance with the description of processing for changing the background color. In the example of FIG. 5, the background color is changed to white.

[Step S17] The script-execution engine 120 returns control to the browser 110. Thereafter, the processing of FIG. 6 is completed, so that it becomes possible for the user to make a manipulation input into an arbitrary item on the screen of the webpage.

Thus, it is possible to display the screen in such a manner that the background color is a specific color (e.g., gray), from the time immediately after the loading of the HTML document 221 until completion of the execution of the script.

An example of the above HTML document in which JavaScript is used as a script language is indicated below.

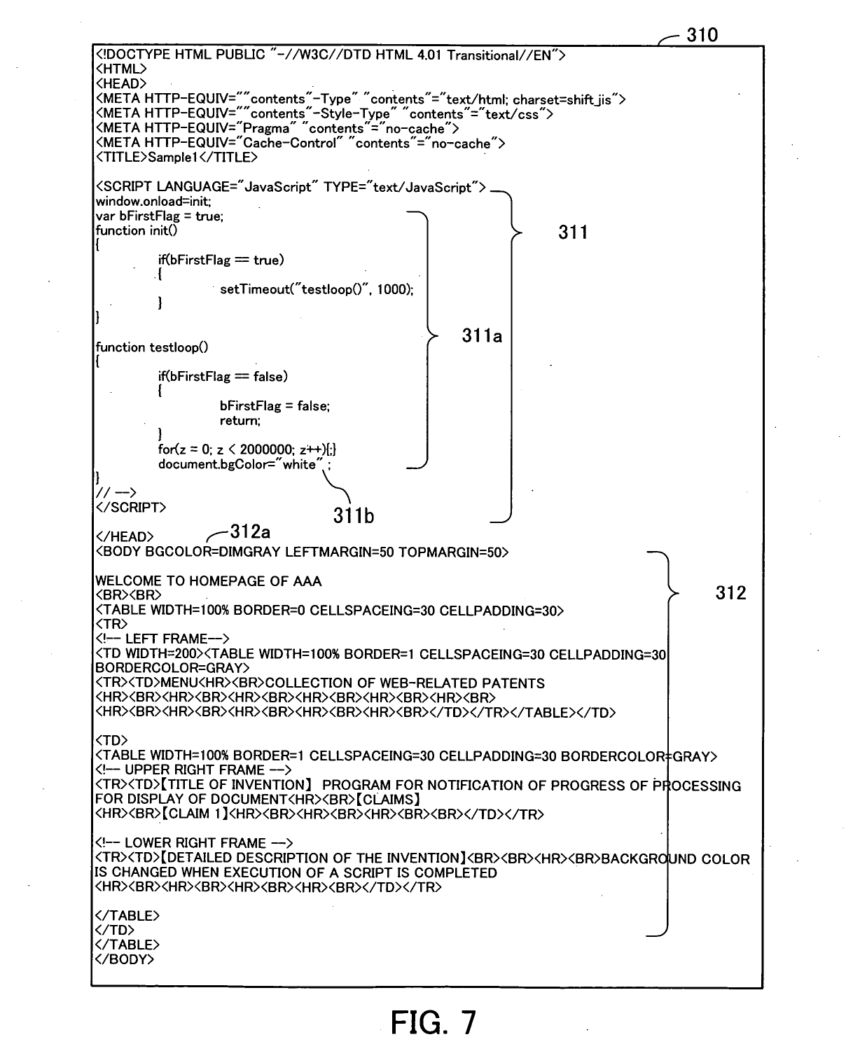

FIG. 7 is a diagram illustrating a first example of an HTML document in the case where the background color is changed. The HTML document 310 contains a script-description portion 311 and a contents-description portion 312.

The script-description portion 311 is a region delimited with the <SCRIPT> tag and the </SCRIPT> tag. The script-description portion 311 is a script which is executed after the contents of the HTML document 310 are displayed on the screen (i.e., a script which is executed on the occurrence of an onLoad event). The script-description portion 311 can be divided into an essential description portion 311a and a background-color-change description portion 311b. The essential description portion 311a is an essential portion of the script to be executed, and describes processing for initial setting and the like, which is performed for executing the script in response to a manipulation input or the like made on a webpage displayed on the screen. In the example of FIG. 7, dummy processing performed when a screen is displayed is described. In the dummy processing, a test loop is executed for a predetermined duration by making the script execution time equal to a predetermined length.

The background-color-change description portion 311b is a script for changing the background color, and is executed after the execution of the essential description portion 311a is completed. (The background-color-change description portion 311b is described at the end of the script in the order of execution.) In the example of FIG. 7, the document.bgcolor property is changed to white (document.bgColor=“white”) at the final stage of the processing described in the script and performed in response to the onLoad event. Thus, the background color is changed to white. Alternatively, the script may further include a description of other simple processing (processing which can be completed in such a short time that the user cannot recognize the processing) in a stage following the above background-color-change description portion 311b.

The contents-description portion 312 is a region delimited with the <BODY> tag and the </BODY> tag. In the contents-description portion 312, the contents to be displayed as a webpage and a manner of display are defined. The <BODY> tag contains a description 312a for designating a background color. In the description 312a for designating a background color, the value of the bgcolor property is designated to be gray (BGCOLOR=GRAY).

Therefore, when the browser 110 loads the HTML document 310 as above, first, a webpage in which the background color is gray is displayed in accordance with the description 312a for designating a background color.

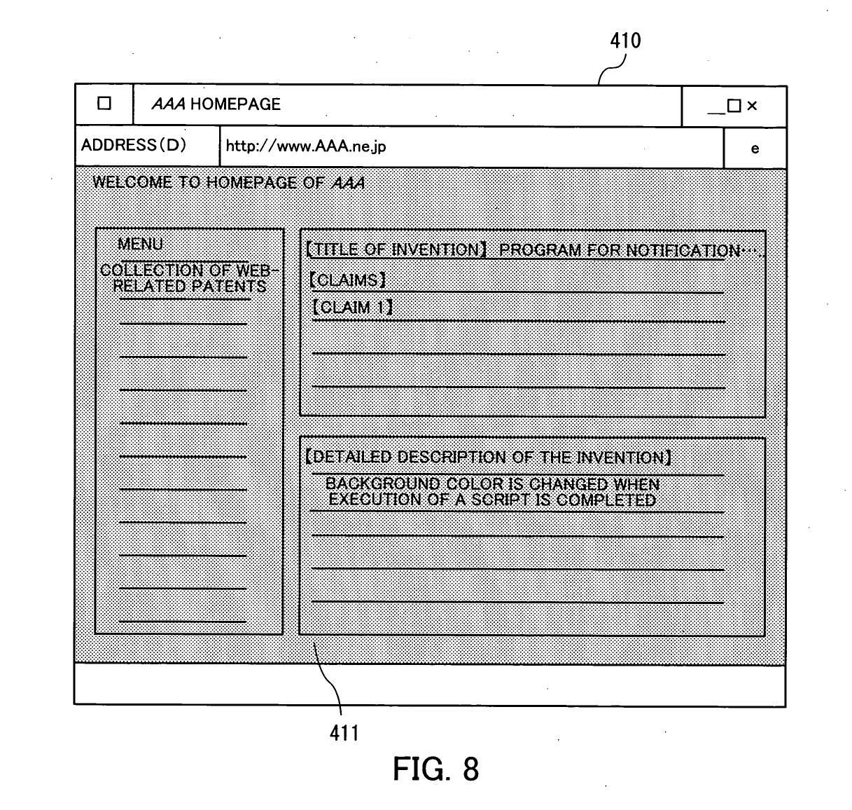

FIG. 8 is a diagram illustrating an example of display of a webpage during execution of the script in the case where the background color is changed. When the browser 110 loads the HTML document 310 as illustrated in FIG. 7, first, the webpage 411 is displayed on the browser screen 410. At this time, in the webpage 411, the contents described in the contents-description portion 312 in the HTML document 310 are displayed in a manner of display defined in the contents-description portion 312. That is, the background is displayed in gray in accordance with the description 312a for designating a background color indicated in FIG. 7. Since the background color is gray, the user can easily recognize that the execution of the script has not yet been completed.

After the operation of displaying the webpage 411 is completed, the processing for initialization in accordance with the script is started by the script-execution engine 120. During the execution of the initialization, the background color in the webpage 411 remains gray. The background color is changed at the final stage of the processing for initialization, and then the processing for initialization is completed.

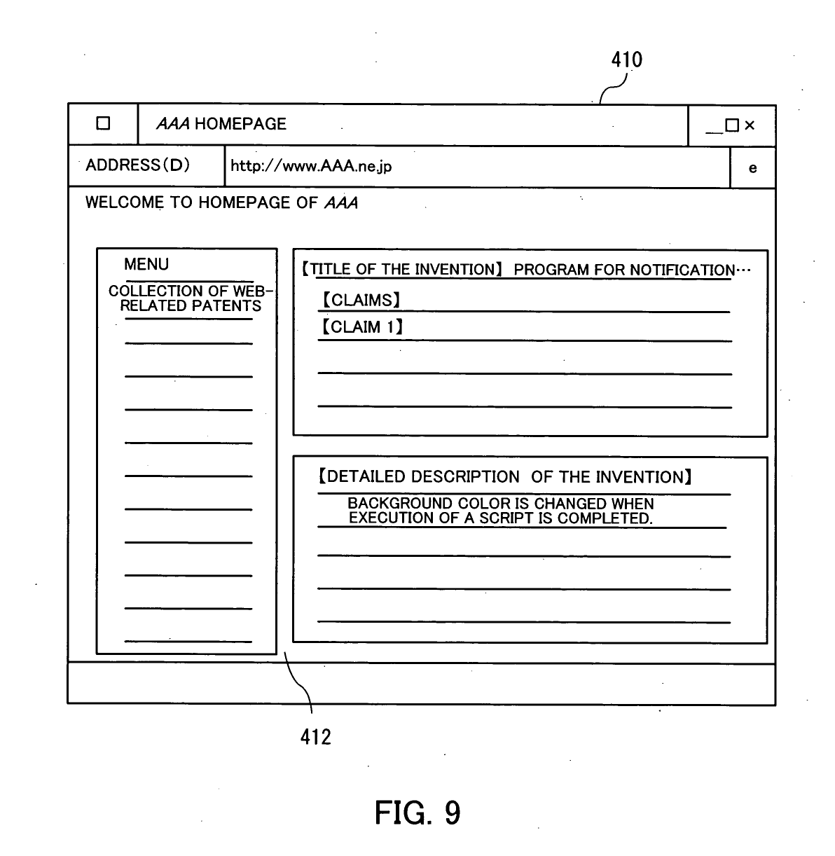

FIG. 9 is a diagram illustrating an example of display of a webpage after completion of execution of the script in the case where the background color is changed. After completion of execution of the script, the webpage 412 to be displayed after completion of execution of the script is displayed in the browser screen 410. The background color of the webpage 412 is white. When the background color changes to white, the user can recognize that the execution of the script is completed, and manipulation input is allowed.

Next, the aforementioned second way of changing the background color is explained below.

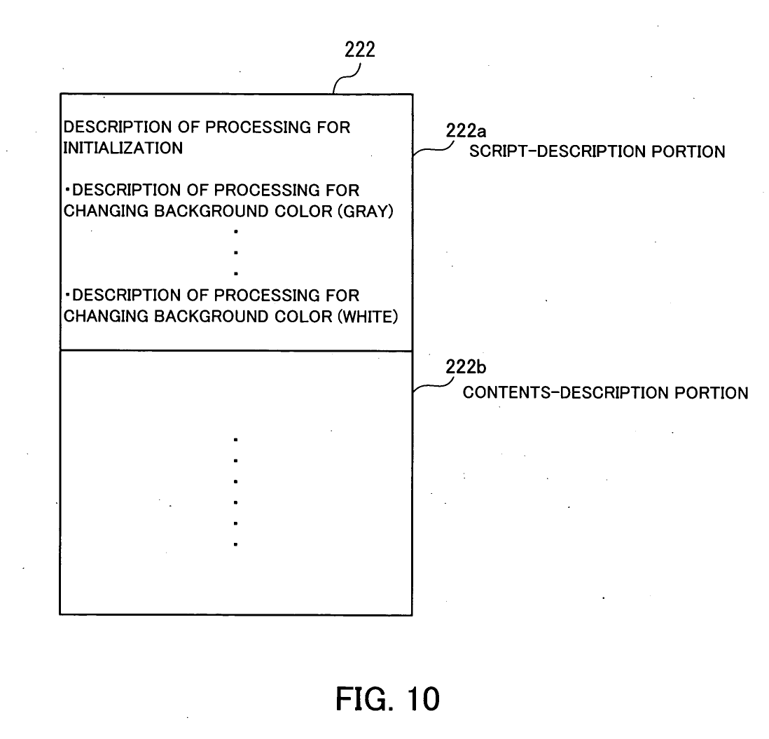

FIG. 10 is a diagram illustrating a second example of an HTML document in the case where the background color is changed. As illustrated in FIG. 10, the HTML document 222 can contain a script-description portion 222a and a contents-description portion 222b. The script-description portion 222a includes descriptions of processing for initialization. The descriptions of processing for initialization include a description of processing for changing the background color in each of the beginning and final stages. The description of processing for changing the background color in the beginning stage is a description of processing for changing the background color to a color indicating that the script is under execution. In the example of FIG. 10, processing for changing the background color to gray immediately after the start of the processing for initialization is described. The description of processing for changing the background color in the final stage is a description of processing for changing the background color to a color indicating that the execution of the script is already completed. In the example of FIG. 10, processing for changing the background color to white immediately before the completion of the processing for initialization is described.

When the client computer 100 acquires from the server computer 200 the HTML document 222 having the contents illustrated in FIG. 10, the browser 110 and the script-execution engine 120 operate in association with each other so as to perform processing for displaying the document.

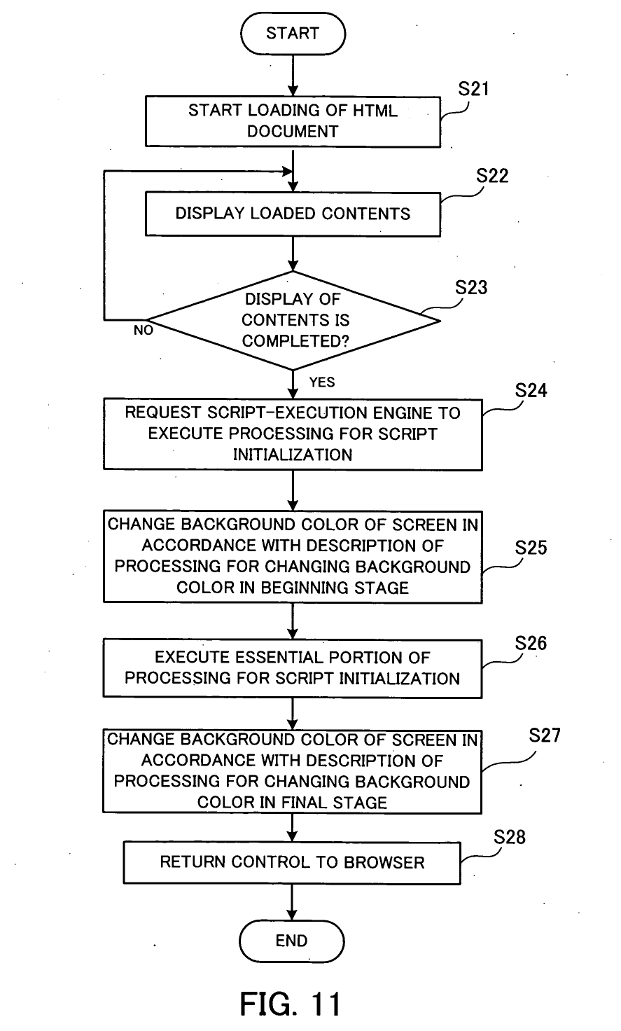

FIG. 11 is a flow diagram of a second example of processing for changing the background color. When the client computer 100 outputs to the server computer 200 a browsing request for the HTML document 222, and the HTML document 222 is sent from the server computer 200 to the client computer 100, the processing of FIG. 11 is started. The processing illustrated in FIG. 11 is explained below step by step.

[Step S21] The browser 110 starts an operation of loading the HTML document 222.

[Step S22] The browser 110 displays the contents of the HTML document 222 which are defined in the contents-description portion 222b of the HTML document 222 loaded as above, in such a manner that the background color is displayed as preset in the browser 110.

[Step S23] The browser 110 determines whether or not the operation of displaying the contents is completed. When no is determined, the operation goes to step S22, and the operation of displaying the contents is continued. When yes is determined, the operation goes to step S24. When the operation of displaying the contents is completed, a status indication of the browser 110 (which is realized by, for example, an icon or a status bar located at an upper right area) indicates a state in which the operation of loading the HTML document 222 is completed.

[Step S24] The browser 110 passes to the script-execution engine 120 information on the script-description portion 222a of the HTML document 222, and requests the script-execution engine 120 to execute the processing for initialization in accordance with the script.

[Step S25] Immediately after the start of the processing for initialization, the script-execution engine 120 changes the background color of the screen in accordance with the description of the processing for changing the background color in the beginning stage. In the example of FIG. 10, the background color is changed to gray.

[Step S26] The script-execution engine 120 executes the processing for initialization in accordance with the script described in the script-description portion 222a (a portion of the script-description portion 222a essential to the initialization).

[Step S27] When the execution of the portion of the script-description portion 222a essential to the initialization is completed, the script-execution engine 120 changes the background color of the screen in accordance with the description of the processing for changing the background color in the final stage. In the example of FIG. 10, the background color is changed to white.

[Step S28] The script-execution engine 120 returns control to the browser 110. Thereafter, the processing of FIG. 11 is completed, so that it becomes possible for the user to make a manipulation input into an arbitrary item on the screen of the webpage.

Thus, it is possible to display the screen in such a manner that the background color is a specific color (e.g., gray), from the time immediately after the loading of the HTML document 222 until completion of the execution of the script.

An example of the above HTML document in which JavaScript is used as a script language is indicated below.

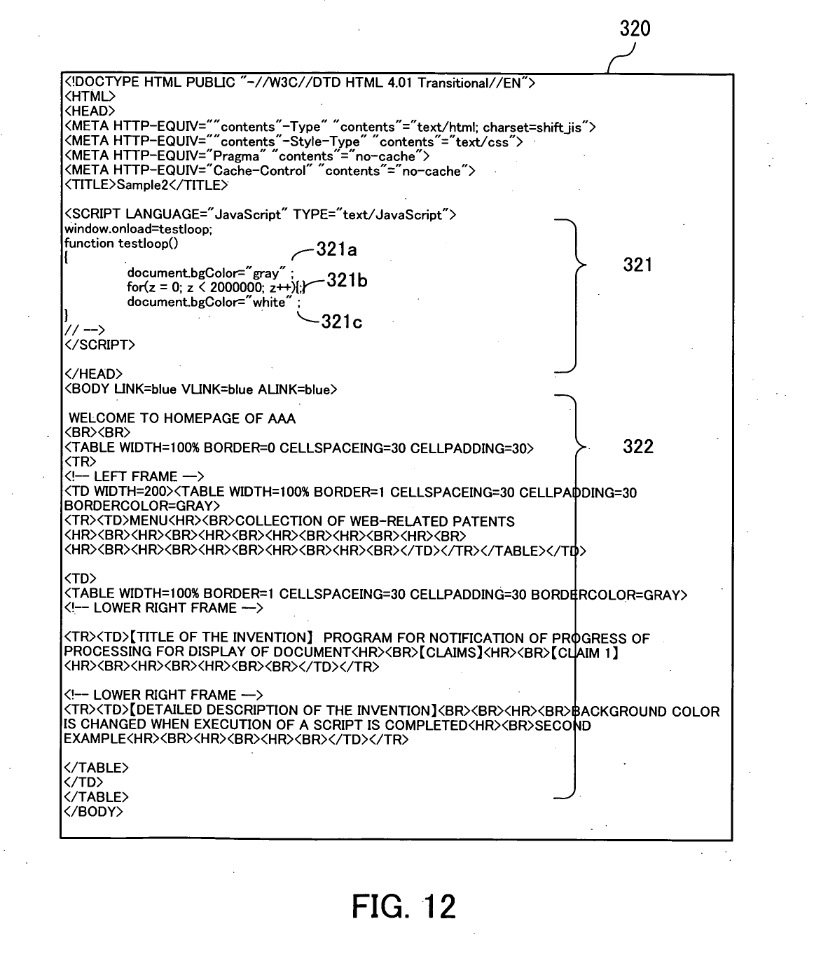

FIG. 12 is a diagram illustrating a second example of an HTML document in the case where the background color is changed. The HTML document 320 contains a script-description portion 321 and a contents-description portion 322.

The script-description portion 321 is a region delimited with the <SCRIPT> tag and the </SCRIPT> tag. The script-description portion 321 is a script which is executed after the contents of the HTML document 320 are displayed on the screen (i.e., a script which is executed on the occurrence of an onLoad event). The script-description portion 321 can be divided into a background-color-change description portion 321a, an essential description portion 321b, and a background-color-change description portion 321c.

The background-color-change description portion 321a is a script for changing the background color, and is executed immediately after the execution of the script-description portion 321 is started. (The background-color-change description portion 321b is described near the beginning of the script in the order of execution.) In the example of FIG. 12, the document.bgcolor property is changed to gray (document.bgColor=“gray”) at the beginning stage of the processing described in the script and performed in response to the onLoad event. Thus, the background color is changed to gray. Alternatively, the script may further include a description of other simple processing (processing which can be completed in such a short time that the user cannot recognize the processing) in a stage preceding the above background-color-change description portion 321a.

The essential description portion 321b is an essential portion of the script to be executed, and describes processing for initial setting and the like, which is performed for executing the script in response to a manipulation input or the like made on a webpage displayed on the screen. In the example of FIG. 12, dummy processing performed when a screen is displayed is described. In the dummy processing, a test loop is executed for a predetermined duration by making the script execution time equal to a predetermined length.

The background-color-change description portion 321c is a script for changing the background color, and is executed after the execution of the essential description portion 321b is completed. (The background-color-change description portion 321c is described at the end of the script in the order of execution.) In the example of FIG. 12, the document.bgcolor property is changed to white (document.bgColor=“white”) at the final stage of the processing described in the script and performed in response to the onLoad event. Thus, the background color is changed to white. Alternatively, the script may further include a description of other simple processing (processing which can be completed in such a short time that the user cannot recognize the processing) in a stage following the above background-color-change description portion 321c.

The contents-description portion 322 is a region delimited with the <BODY> tag and the </BODY> tag. In the contents-description portion 322, the contents to be displayed as a webpage and a manner of display are defined.

Therefore, when the browser 110 loads the HTML document 320 as above, the background color is changed to gray immediately after the start of the initialization in accordance with the script. Thereafter, when the execution of the initialization in accordance with the script is completed, the background color is changed to white. At this time, the screen changes, for example, as illustrated in FIGS. 8 and 9.

[In the Case where Text Color is Changed]

For example, it is possible to differentiate the text color displayed during execution of a script from the text color displayed after completion of the execution of the script, in the following two ways.

In the first way, a text color which is to be displayed during execution of a script is defined in advance in a portion of the contents of an HTML document. Thereafter, when initialization in accordance with the script is completed, the text color is changed to a text color which is to be displayed after completion of the execution of the script.

In the second way, the text color which is to be displayed during execution of a script is set when initialization in accordance with the script is started. Thereafter, when the initialization in accordance with the script is completed, the text color is changed to a text color which is to be displayed after completion of the execution of the script.

The first way of changing the text color is explained below.

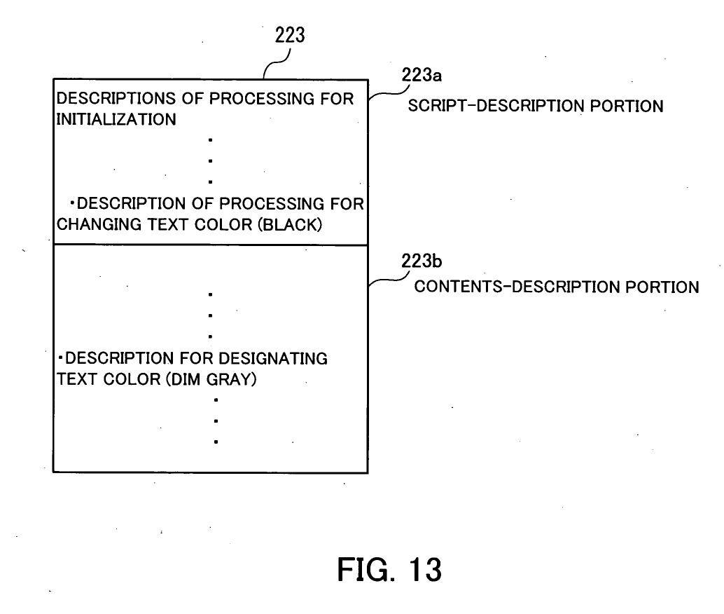

FIG. 13 is a diagram illustrating a first example of an HTML document in the case where the text color is changed. As illustrated in FIG. 13, the HTML document 223 can contain a script-description portion 223a and a contents-description portion 223b. The script-description portion 223a includes descriptions of processing for initialization. The descriptions of processing for initialization constitute a script which is executed when a download of the HTML document 223 is completed and a screen based on the contents-description portion 223b is displayed. The descriptions of processing for initialization include a description of processing for changing the text color as a description of processing in the final stage. In the example of FIG. 13, processing for changing the text color to black is described.

The contents-description portion 223b is a portion in which the contents of the document to be displayed are defined in HTML. The contents-description portion 223b includes a description for designating a text color. In the example of FIG. 13, dim gray is designated as the text color.

When the client computer 100 acquires from the server computer 200 the HTML document 223 having the contents illustrated in FIG. 13, the browser 110 and the script-execution engine 120 operate in association with each other so as to perform processing for displaying the document. At this time, a sequence similar to the sequence of FIG. 6 is executed except that the contents loaded as above are displayed in the text color in accordance with the description for designating the text color in a step corresponding to the step S12 in FIG. 6, and the text color in the screen is changed in accordance with the description of processing for changing the text color in a step corresponding to the step S16 in FIG. 6.

Thus, it is possible to display the screen in such a manner that the text color is a specific color (e.g., dim gray), from the time immediately after the loading of the HTML document 223 until completion of the execution of the script.

An example of the above HTML document in which JavaScript is used as a script language is indicated below.

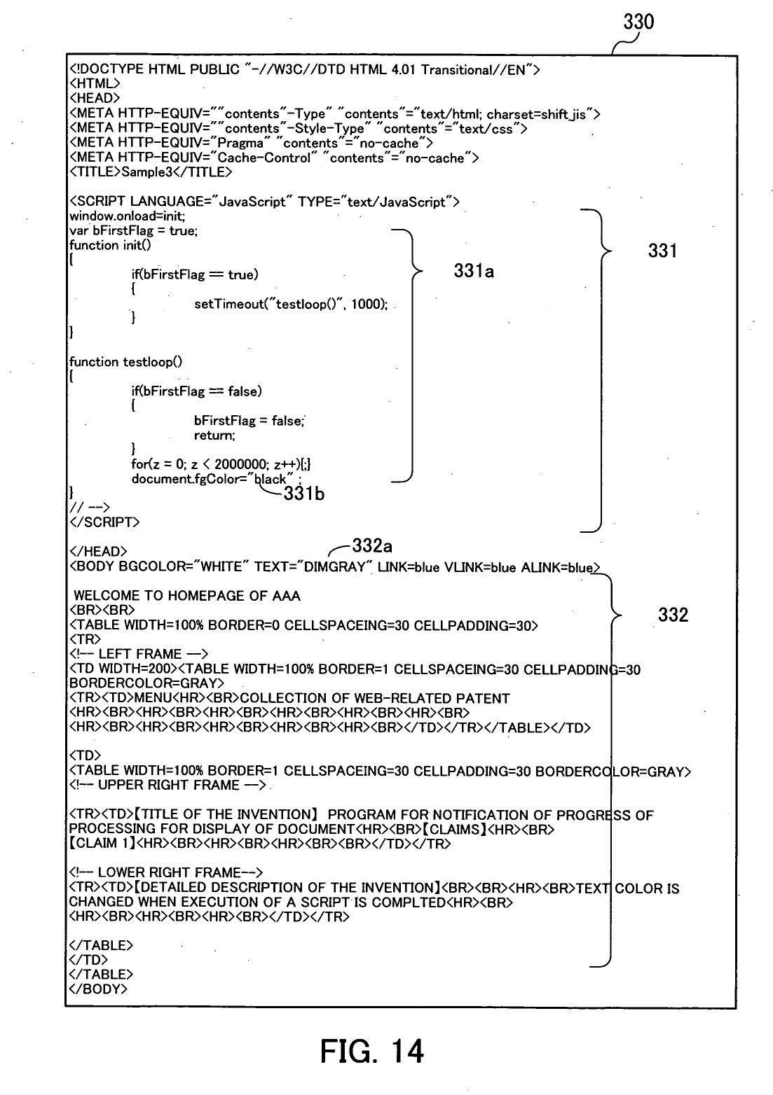

FIG. 14 is a diagram illustrating a first example of an HTML document in the case where the text color is changed. The HTML document 330 contains a script-description portion 331 and a contents-description portion 332.

The script-description portion 331 is a region delimited with the <SCRIPT> tag and the </SCRIPT> tag. The script-description portion 331 is a script which is executed after the contents of the HTML document 330 are displayed on the screen (i.e., a script which is executed on the occurrence of an onLoad event). The script-description portion 331 can be divided into an essential description portion 331a and a text-color-change description portion 331b.

The essential description portion 331a is an essential portion of the script to be executed, and the text-color-change description portion 331b is a script for changing the text color, and is executed after the execution of the essential description portion 331a is completed. (The text-color-change description portion 331b is described at the end of the script in the order of execution.) In the example of FIG. 14, the document.fgcolor property is changed to black (document.fgColor=“black”) at the final stage of the processing described in the script and performed on the occurrence of the onLoad event. Thus, the text color is changed to black. Alternatively, the script may further include a description of other simple processing (processing which can be completed in such a short time that the user cannot recognize the processing) in a stage following the above text-color-change description portion 331b.

The contents-description portion 332 is a region delimited with the <BODY> tag and the </BODY> tag. In the contents-description portion 332, the contents to be displayed as a webpage and a manner of display are defined. The <BODY> tag contains a description 332a for designating a text color. In the description 332a for designating a text color, the value of the TEXT property is designated to be dim gray (TEXT=“DIMGRAY”).

Therefore, when the browser 110 loads the HTML document 330 as above, first, a webpage in which the text color is dim gray is displayed.

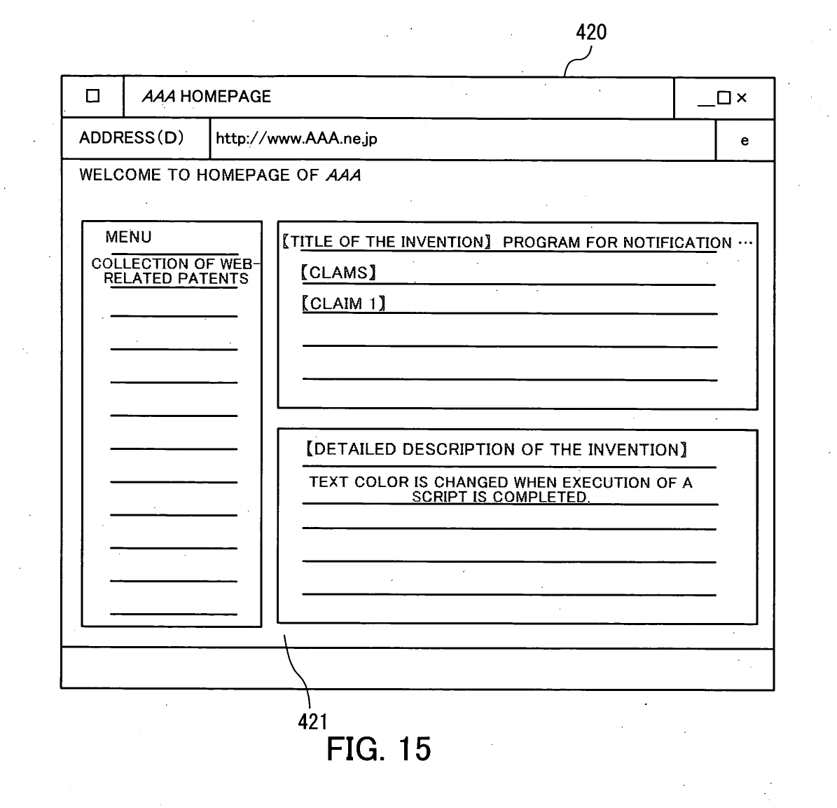

FIG. 15 is a diagram illustrating an example of display of a webpage during execution of the script in the case where the text color is changed. When the browser 110 loads the HTML document 330 as illustrated in FIG. 14, first, the webpage 421 is displayed in the browser screen 420. At this time, in the webpage 421, the contents described in the contents-description portion 332 in the HTML document 330 are displayed in a manner of display defined in the contents-description portion 332. That is, the text is displayed in dim gray in accordance with the description 332a for designating the text color indicated in FIG. 14. Since the text color is dim gray, the user can easily recognize that the execution of the script has not yet been completed.

After the operation of displaying the webpage 421 is completed, the processing for initialization in accordance with the script is started by the script-execution engine 120. During the execution of the initialization, the text color in the webpage 421 remains dim gray. The text color is changed to black at the final stage of the processing for initialization, and then the processing for initialization is completed.

Next, the aforementioned second way of changing the text color is explained below.

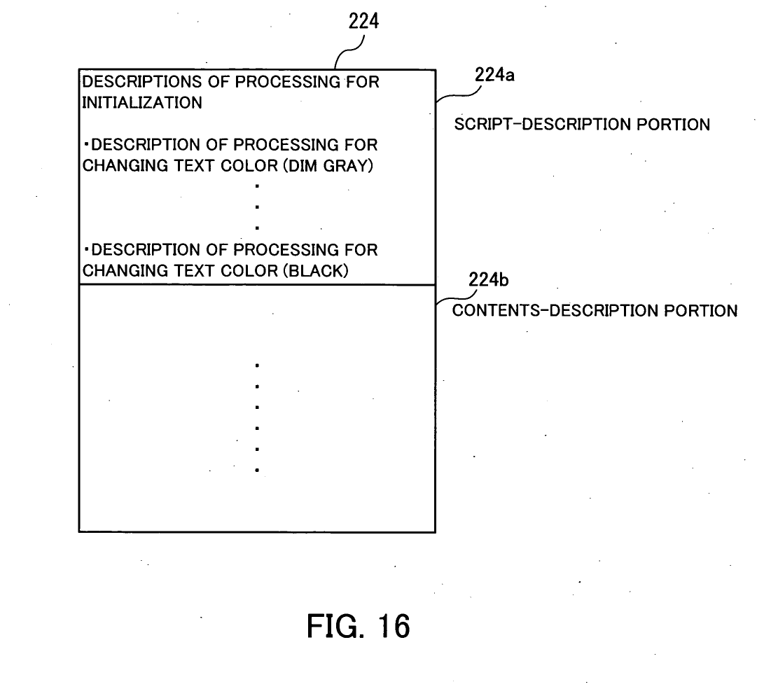

FIG. 16 is a diagram illustrating a second example of an HTML document in the case where the text color is changed. As illustrated in FIG. 16, the HTML document 224 can contain a script-description portion 224a and a contents-description portion 224b. The script-description portion 224a includes descriptions of processing for initialization. The descriptions of processing for initialization include a description of processing for changing the text color in each of the beginning and final stages. The description of processing for changing the text color in the beginning stage is a description of processing for changing the text color to a color indicating that the script is under execution. In the example of FIG. 16, processing for changing the text color to dim gray immediately after the start of the processing for initialization is described. The description of processing for changing the text color in the final stage is a description of processing for changing the text color to a color indicating that the execution of the script is already completed. In the example of FIG. 16, processing for changing the text color to black immediately before the completion of the processing for initialization is described.

When the client computer 100 acquires from the server computer 200 the HTML document 224 having the contents illustrated in FIG. 16, the browser 110 and the script-execution engine 120 operate in association with each other so as to perform processing for displaying the document. At this time, a sequence similar to the sequence of FIG. 11 is executed except for the steps S25 and S27 in FIG. 11. In a step corresponding to the step S25 in FIG. 11, the text color is changed in accordance with the description of processing for changing the text color in the beginning stage. In a step corresponding to the step S27 in FIG. 11, the text color is changed in accordance with the description of processing for changing the text color in the final stage.

Thus, it is possible to display the screen in such a manner that the text color is a specific color (e.g., dim gray), from the time immediately after the loading of the HTML document 224 until completion of the execution of the script.

An example of the above HTML document in which JavaScript is used as a script language is indicated below.

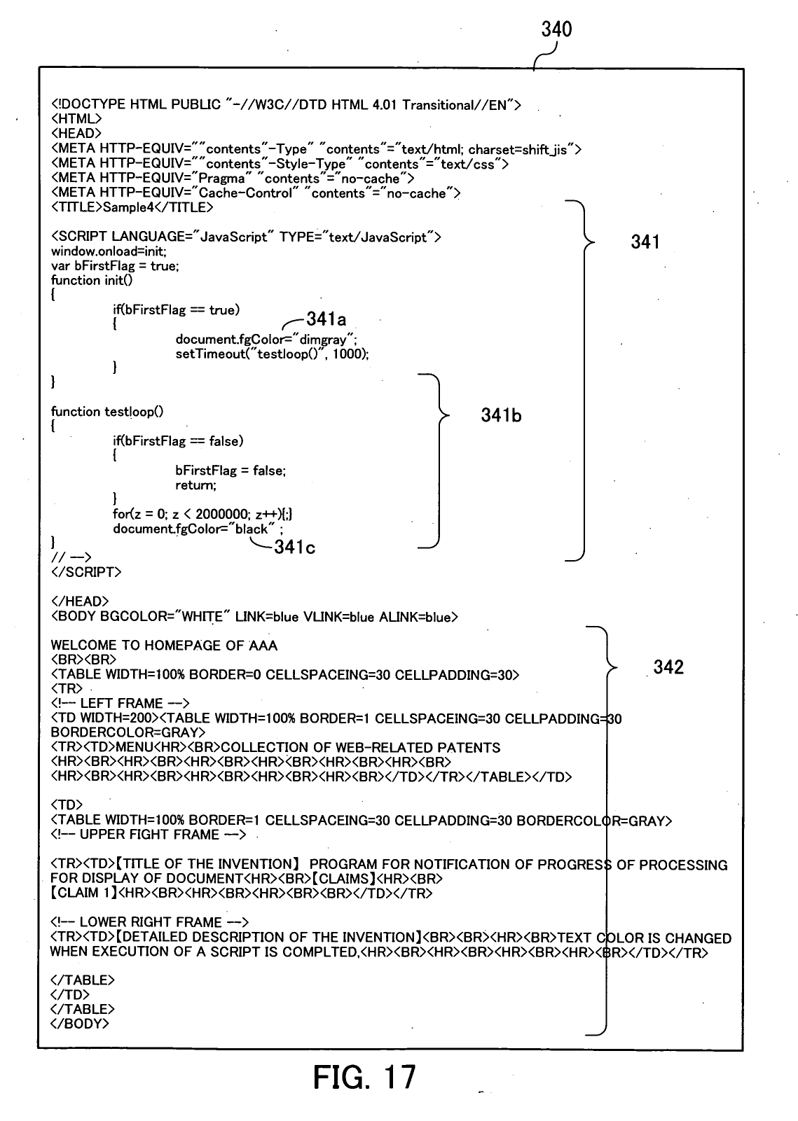

FIG. 17 is a diagram illustrating a second example of an HTML document in the case where the text color is changed. The HTML document 340 contains a script-description portion 341 and a contents-description portion 342.

The script-description portion 341 is a region delimited with the <SCRIPT> tag and the </SCRIPT> tag. The script-description portion 341 is a script which is executed after the contents of the HTML document 340 are displayed on the screen (i.e., a script which is executed on the occurrence of an onLoad event). The script-description portion 341 can be divided into a text-color-change description portion 341a, an essential description portion 341b, and a text-color-change description portion 341c.

The text-color-change description portion 341a is a script for changing the text color to a text color to be displayed during execution of a script, and is executed immediately after the execution of the script-description portion 341 is started. (The text-color-change description portion 341b is described near the beginning of the script in the order of execution.) In the example of FIG. 17, the document.fgcolor property is changed to gray (document.fgColor=“dimgray”) at the beginning stage of the processing described in the script and performed on the occurrence of the onLoad event. Thus, the text color is changed to dim gray. Alternatively, the script may further include a description of other simple processing (processing which can be completed in such a short time that the user cannot recognize the processing) in a stage preceding the above text-color-change description portion 341a.

The essential description portion 341b is an essential portion of the script to be executed. In the example of FIG. 17, dummy processing performed when a screen is displayed is described. In the dummy processing, a test loop is executed for a predetermined duration by making the script execution time equal to a predetermined length.

The text-color-change description portion 341c is a script for changing the text color to a text color to be displayed after completion of execution of a script, and is executed after the execution of the essential description portion 341b is completed. (The text-color-change description portion 341c is described at the end of the script in the order of execution.) In the example of FIG. 17, the document.fgcolor property is changed to black (document.fgColor=“black”) at the final stage of the processing described in the script and performed on the occurrence of the onLoad event. Thus, the text color is changed to black. Alternatively, the script may further include a description of other simple processing (processing which can be completed in such a short time that the user cannot recognize the processing) in a stage following the above text-color-change description portion 341c.

The contents-description portion 342 is a region delimited with the <BODY> tag and the </BODY> tag. In the contents-description portion 342, the contents to be displayed as a webpage and a manner of display are defined.

Therefore, when the browser 110 loads the HTML document 340 as above, the text color is changed to dim gray immediately after the start of the initialization in accordance with the script. Thereafter, when the execution of the initialization in accordance with the script is completed, the text color is changed to black. At this time, the screen is displayed, for example, as illustrated in FIG. 15.

[In The Case Where Background Color And Text Color Are Changed]

For example, it is possible to differentiate the background color and the text color displayed during execution of a script from the background color and the text color displayed after completion of the execution of the script, in the following two ways.

In the first way, a background color and a text color which are to be displayed during execution of a script are defined in advance in a portion of the contents of an HTML document. Thereafter, when initialization in accordance with the script is completed, the background color and the text color are respectively changed to a background color and a text color which are to be displayed after completion of the execution of the script.

In the second way, the background color and the text color which are to be displayed during execution of a script is set when initialization in accordance with the script is started. Thereafter, when the initialization in accordance with the script is completed, the background color and the text color are changed to a background color and a text color which are to be displayed after completion of the execution of the script.

The first way of changing the background color and the text color is explained below.

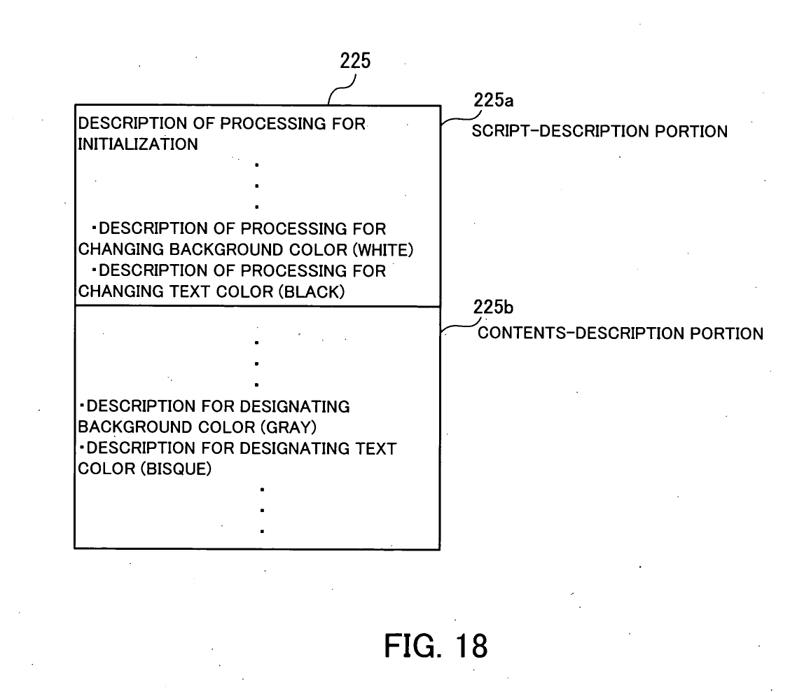

FIG. 18 is a diagram illustrating a first example of an HTML document in the case where the background color and the text color are changed. As illustrated in FIG. 18, the HTML document 225 can contain a script-description portion 225a and a contents-description portion 225b. The script-description portion 225a includes descriptions of processing for initialization. The descriptions of processing for initialization include as descriptions of processing in the final stage a description of processing for changing the background color and a description of processing for changing the text color. In the example of FIG. 18, processing for changing the background color to white and the text color to black is described.

The contents-description portion 225b is a portion in which the contents of the document to be displayed are defined in HTML. The contents-description portion 225b includes descriptions for designating a background color and a text color. In the example of FIG. 18, gray is designated as the background color, and bisque (i.e., the color of the unglazed pottery) is designated as the text color.

When the client computer 100 acquires from the server computer 200 the HTML document 225 having the contents illustrated in FIG. 18, the browser 110 and the script-execution engine 120 operate in association with each other so as to perform processing for displaying the document. At this time, a sequence similar to the sequence of FIG. 6 is executed except for the steps S12 and S16 in FIG. 6. That is, in a step corresponding to the step S12 in FIG. 6, the contents loaded as above are displayed so that the background color is in accordance with the description for designating a background color, and the text color is in accordance with the description for designating a text color. In addition, in a step corresponding to the step S16 in FIG. 6, the background color in the screen is changed in accordance with the description of processing for changing the background color, and the text color is changed in accordance with the description of processing for changing the text color.

Thus, it is possible to display the screen in such a manner that the background color and the text color are specific colors, from the time immediately after the loading of the HTML document 225 until completion of the execution of the script.

An example of the above HTML document in which JavaScript is used as a script language is indicated below.

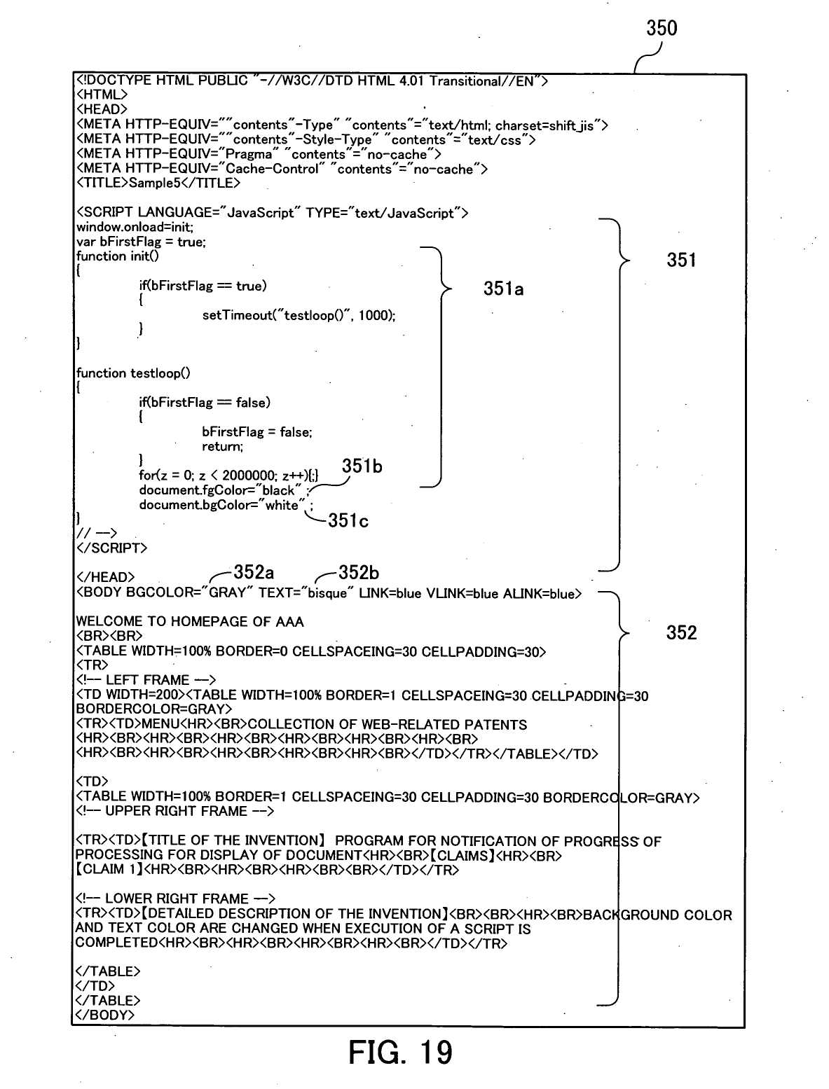

FIG. 19 is a diagram illustrating a first example of an HTML document in the case where the background color and the text color are changed. The HTML document 350 contains a script-description portion 351 and a contents-description portion 352.

The script-description portion 351 is a region delimited with the <SCRIPT> tag and the </SCRIPT> tag. The script-description portion 351 is a script which is executed after the contents of the HTML document 350 are displayed on the screen (i.e., a script which is executed on the occurrence of an onLoad event). The script-description portion 351 can be divided into an essential description portion 351a, a text-color-change description portion 351b, and a background-color-change description portion 351c.

The essential description portion 351a is an essential portion of the script to be executed, the text-color-change description portion 351b is a script for changing the text color, and the background-color-change description portion 351c is a script for changing the background color. The text-color-change description portion 351b and the background-color-change description portion 351c are executed after the execution of the essential description portion 351a is completed. (The text-color-change description portion 351b and the background-color-change description portion 351c are described at the end of the script in the order of execution.) In the example of FIG. 19, at the final stage of the processing described in the script and performed on the occurrence of the onLoad event, the document.fgcolor property is changed to black (document.fgColor=“black”), and the document.bgcolor property is changed to white (document.bgColor=“white”). Thus, the text color is changed to black, and the background color is changed to white. Alternatively, the script may further include a description of other simple processing (processing which can be completed in such a short time that the user cannot recognize the processing) in a stage following the background-color-change description portion 351c.

The contents-description portion 352 is a region delimited with the <BODY> tag and the </BODY> tag. In the contents-description portion 352, the contents to be displayed as a webpage and a manner of display are defined. The <BODY> tag contains a description 352a for designating a background color and a description 352b for designating a text color. In the description 352a for designating a background color, the value of the bgcolor property is designated to be gray (BGCOLOR=“GRAY”). In the description 352b for designating a text color, the value of the TEXT property is designated to be bisque (TEXT=“bisque”).

Therefore, when the browser 110 loads the HTML document 350 as above, first, a webpage is displayed with a gray background and a bisque text.

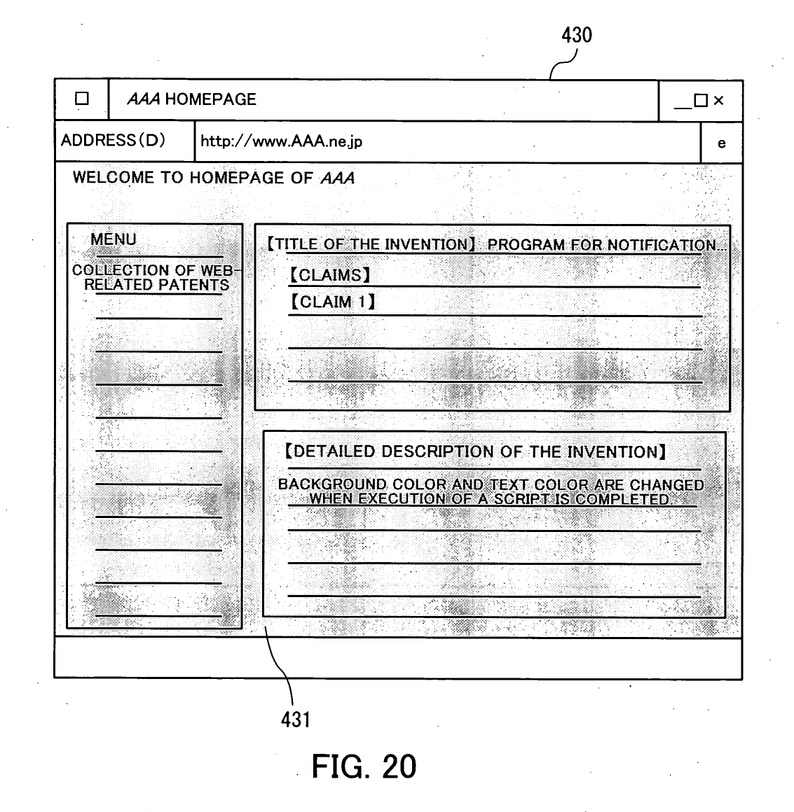

FIG. 20 is a diagram illustrating an example of display of a webpage during execution of the script in the case where the background color and the text color are changed. When the browser 110 loads the HTML document 350 as illustrated in FIG. 19, first, the webpage 431 is displayed in the browser screen 430. At this time, in the webpage 431, the contents described in the contents-description portion 352 in the HTML document 350 are displayed in a manner of display defined in the contents-description portion 352. That is, the background is displayed in gray in accordance with the description 352a for designating a background color indicated in FIG. 19, and the text is displayed in bisque in accordance with the description 352b for designating the text color. Since the background color is gray, and the text color is bisque, the user can easily recognize that the execution of the script has not yet been completed.

After the operation of displaying the webpage 431 is completed, the processing for initialization in accordance with the script is started by the script-execution engine 120. During the execution of the initialization, the background color in the webpage 431 remains gray, and the text color remains bisque. At the final stage of the processing for initialization, the background color is changed to white, and the text color is changed to black. Then, the processing for initialization in accordance with the script is completed.

Next, the aforementioned second way of changing the background color and the text color is explained below.

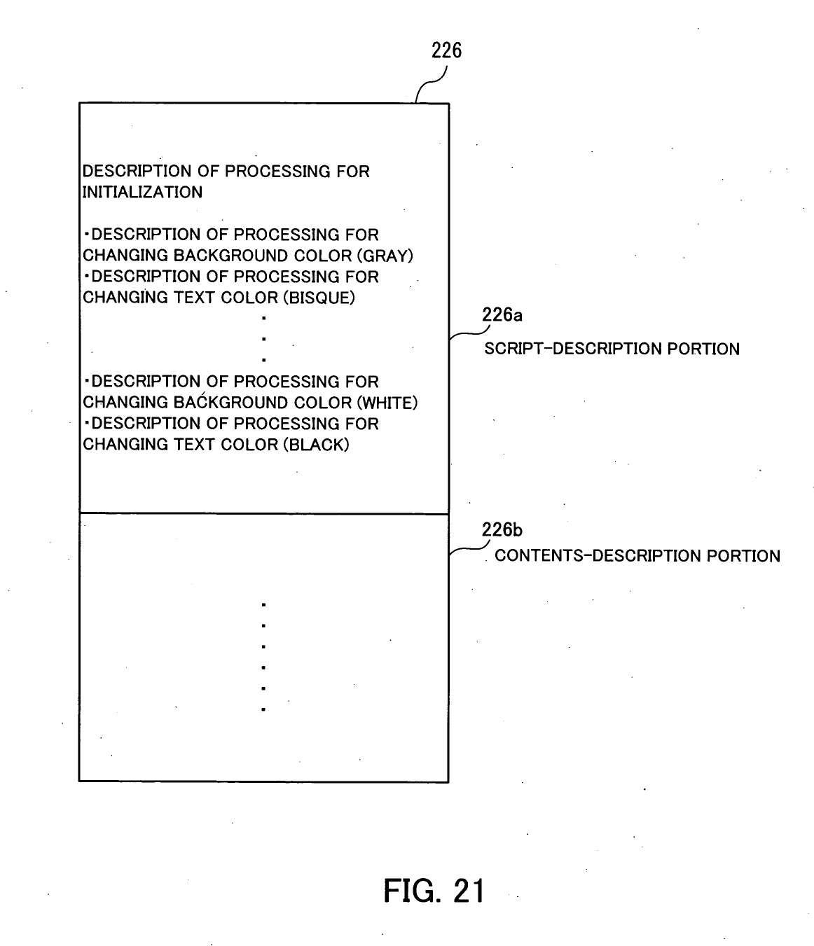

FIG. 21 is a diagram illustrating a second example of an HTML document in the case where the background color and the text color are changed. As illustrated in FIG. 21, the HTML document 226 can contain a script-description portion 226a and a contents-description portion 226b. The script-description portion 226a includes descriptions of processing for initialization. The descriptions of processing for initialization include descriptions of processing for changing the background color and the text color in each of the beginning and final stages. The description of processing for changing the background color in the beginning stage is a description of processing for changing the background color to a color indicating that the script is under execution. In the example of FIG. 21, processing for changing the background color to gray immediately after the start of the processing for initialization is described. The description of processing for changing the text color in the beginning stage is a description of processing for changing the text color to a color indicating that the script is under execution. In the example of FIG. 21, processing for changing the text color to bisque immediately after the start of the processing for initialization is described. The description of processing for changing the background color in the final stage is a description of processing for changing the background color to a color indicating that the execution of the script is already completed. In the example of FIG. 21, processing for changing the background color to white immediately before the completion of the processing for initialization is described. The description of processing for changing the text color in the final stage is a description of processing for changing the text color to a color indicating that the execution of the script is already completed. In the example of FIG. 21, processing for changing the text color to black immediately before the completion of the processing for initialization is described.

When the client computer 100 acquires from the server computer 200 the HTML document 226 having the contents illustrated in FIG. 21, the browser 110 and the script-execution engine 120 operate in association with each other so as to perform processing for displaying the document. At this time, a sequence similar to the sequence of FIG. 11 is executed except for the steps S25 and S27 in FIG. 11. In a step corresponding to the step S25 in FIG. 11, the background color is changed in accordance with the description of processing for changing the background color in the beginning stage, and the text color is changed in accordance with the description of processing for changing the text color in the beginning stage. In a step corresponding to the step S27 in FIG. 11, the background color is changed in accordance with the description of processing for changing the background color in the final stage, and the text color is changed in accordance with the description of processing for changing the text color in the final stage.

Thus, it is possible to display the screen in such a manner that the background color and the text color are specific colors (e.g., the background color is gray, and the text color is bisque), from the time immediately after the loading of the HTML document 226 until completion of the execution of the script.

An example of the above HTML document in which JavaScript is used as a script language is indicated below.

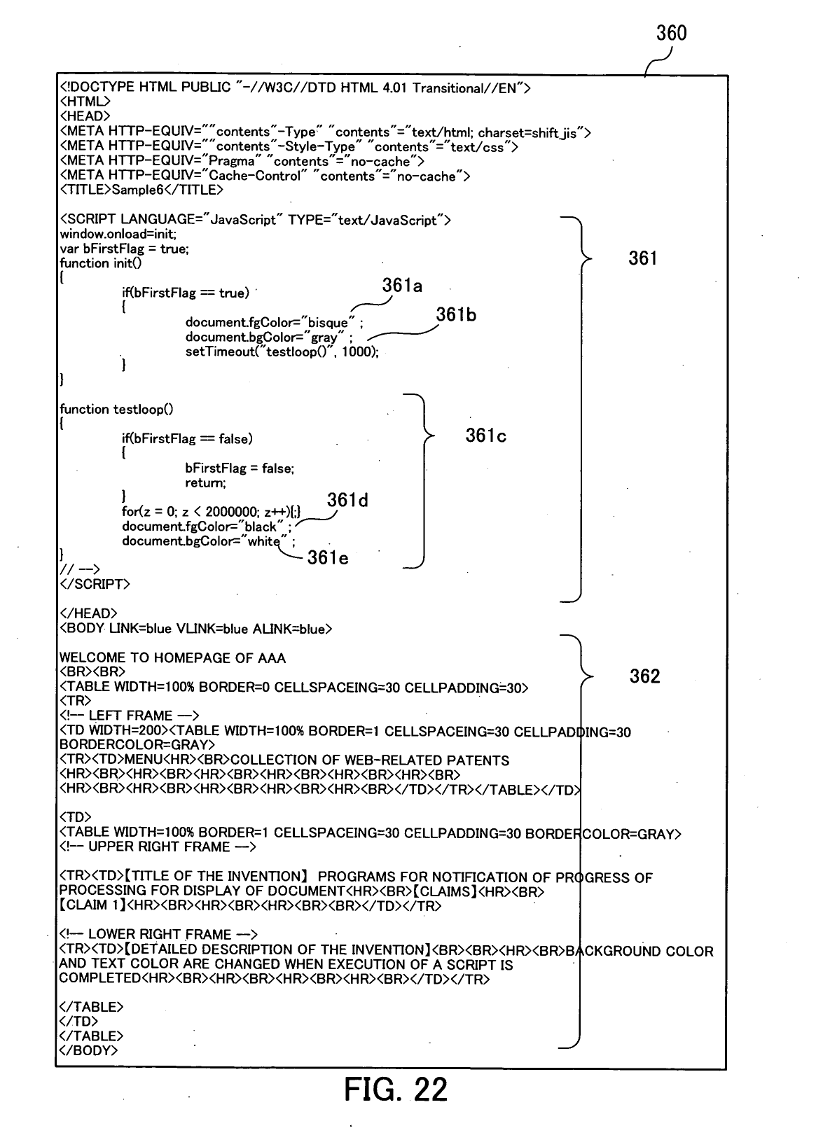

FIG. 22 is a diagram illustrating a second example of an HTML document in the case where the background color and the text color are changed. The HTML document 360 contains a script-description portion 361 and a contents-description portion 362.

The script-description portion 361 is a region delimited with the <SCRIPT> tag and the </SCRIPT> tag. The script-description portion 361 is a script which is executed after the contents of the HTML document 360 are displayed on the screen (i.e., a script which is executed on the occurrence of an onLoad event). The script-description portion 361 can be divided into a text-color-change description portion 361a in the beginning stage, a background-color-change description portion 361b in the beginning stage, an essential description portion 361c, a text-color-change description portion 361d in the final stage, and a background-color-change description portion 361e in the final stage.

The text-color-change description portion 361a in the beginning stage is a script for changing the text color to a text color to be displayed during execution of a script. In the example of FIG. 22, the document.fgcolor property is changed to bisque (document.fgColor=“bisque”) at the beginning stage of the processing described in the script and performed on the occurrence of the onLoad event. Thus, the text color is changed to bisque.

The background-color-change description portion 361b in the beginning stage is a script for changing the background color to a background color to be displayed during execution of a script. In the example of FIG. 22, the document.bgcolor property is changed to gray (document.bgColor=“gray”) at the beginning stage of the processing described in the script and performed on the occurrence of the onLoad event. Thus, the background color is changed to gray.

The essential description portion 361c is an essential portion of the script to be executed. In the example of FIG. 22, dummy processing performed when a screen is displayed is described. In the dummy processing, a test loop is executed for a predetermined duration by making the script execution time equal to a predetermined length.

The text-color-change description portion 361d in the final stage is a script for changing the text color to a text color to be displayed after completion of execution of a script. In the example of FIG. 22, the document.fgcolor property is changed to black (document.fgColor=“black”) at the final stage of the processing described in the script and performed on the occurrence of the onLoad event. Thus, the text color is changed to black.

The background-color-change description portion 361e in the final stage is a script for changing the background color to a background color to be displayed after completion of execution of a script. In the example of FIG. 22, the document.bgcolor property is changed to white (document.bgColor=“white”) at the final stage of the processing described in the script and performed on the occurrence of the onLoad event. Thus, the background color is changed to white.

The contents-description portion 362 is a region delimited with the <BODY> tag and the </BODY> tag. In the contents-description portion 362, the contents to be displayed as a webpage and a manner of display are defined.

Therefore, when the browser 110 loads the HTML document 360 as above, immediately after the start of the initialization in accordance with the script, the text color is changed to bisque, and the background color is changed to gray. Thereafter, when the execution of the initialization in accordance with the script is completed, the text color is changed to black, and the background color is changed to white. At this time, the screen is displayed, for example, as illustrated in FIG. 20.

[In the Case where Image is Changed]

In the case where an image displayed during execution of a script is differentiated from an image displayed after completion of the execution of the script, another image is stored in advance, separately from the HTML document, in the server computer.

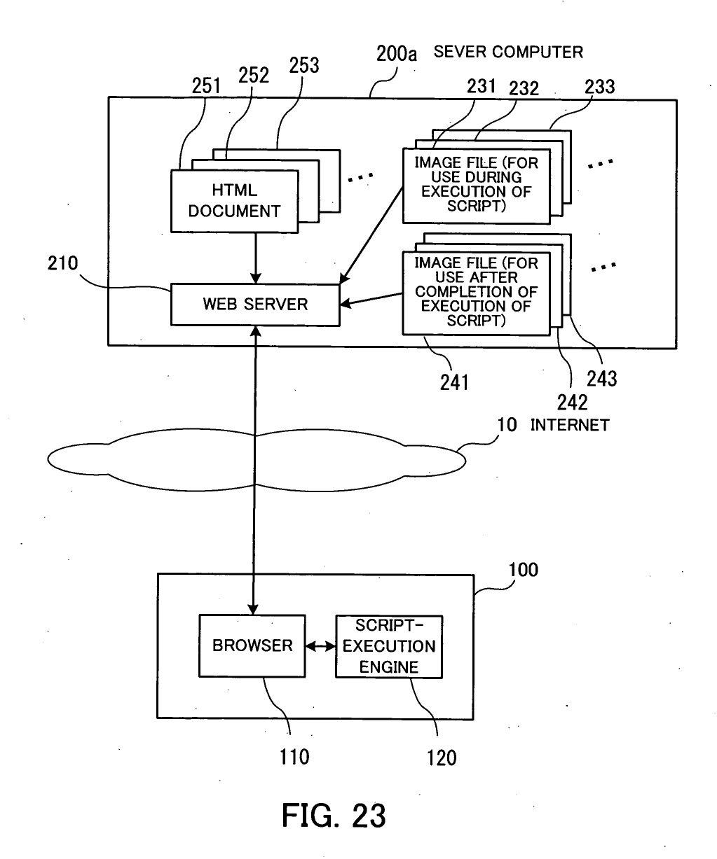

FIG. 23 is a diagram illustrating an example of a construction of a system in the case where images are changed. In the construction illustrated in FIG. 23, the same elements as the corresponding elements in the construction of FIG. 4 bear the same reference numerals as FIG. 4, respectively.

In the case where an image displayed during execution of a script is differentiated from an image displayed after completion of the execution of the script, the server computer 200a stores image files 231, 232, 233, . . . , image files 241, 242, 243, . . . , and HTML documents 251, 252, 253, . . . .

The image files 231, 232, 233, . . . are image files prepared for being displayed during execution of a script. The image files 231, 232, 233, . . . represent images which can make users easily notice that a script is under execution. For example, the image files 231, 232, 233, . . . represent monochrome images. Since the amounts of data representing the monochrome images are smaller than the amounts of data representing the color images, the use of the monochrome images can reduce the downloading time of the image files.

The image files 241, 242, 243, . . . are image files prepared for being displayed after completion of execution of a script. The image files 241, 242, 243, . . . represent images which are to be provided to users by webpages. For example, in the case where the image files 231, 232, 233, . . . , which are prepared for being displayed during execution of a script, represent monochrome images, the image files 241, 242, 243, . . . represent color images. Thereby, users can recognize that a script is under execution until a monochrome image is switched to a color image.

In the HTML documents 251, 252, 253, . . . , the image files 231, 232, 233, . . . , which are prepared for being displayed during execution of a script, are designated as background images or main images which are to be displayed during execution of a script. In addition, in the HTML documents 251, 252, 253, . . . , the image files 241, 242, 243, . . . , which are prepared for being displayed after completion of execution of a script, are designated as background images or main images which are to be displayed after completion of execution of a script.

For example, it is possible to differentiate an image displayed during execution of a script from an image displayed after completion of the execution of the script, in the following two ways.

In the first way, an image file which is to be used for display during execution of a script is defined in advance in a portion of the contents of an HTML document. Thereafter, when initialization in accordance with the script is completed, the designation of the image file is changed to another image which is to be used for display after completion of the execution of the script.

In the second way, processing for displaying an image file which is to be used for during execution of a script is designated when initialization in accordance with the script is started. Thereafter, when the initialization in accordance with the script is completed, the designation of the image file is changed to another image file which is to be used after completion of the execution of the script.

The first way of changing an image is explained below.

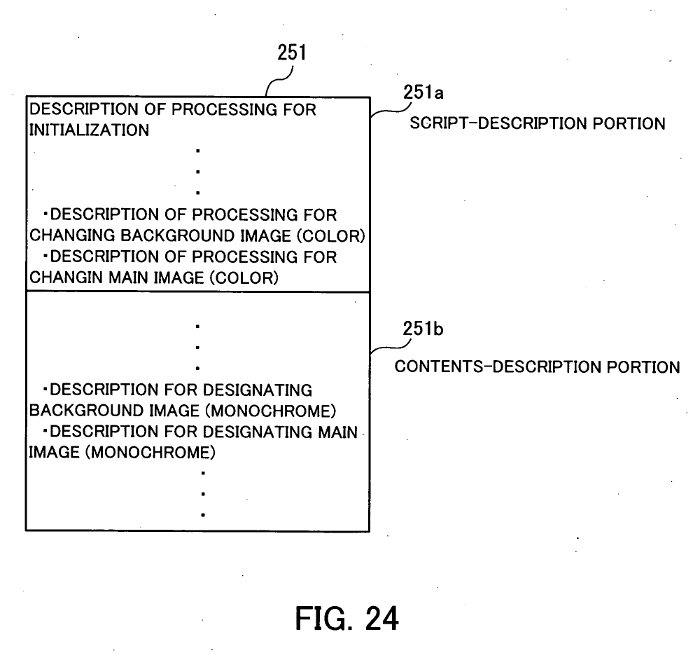

FIG. 24 is a diagram illustrating a first example of an HTML document in the case where images are changed. As illustrated in FIG. 24, the HTML document 251 can contain a script-description portion 251a and a contents-description portion 251b. The script-description portion 251a includes descriptions of processing for initialization. The descriptions of processing for initialization include as descriptions of processing in the final stage descriptions of processing for changing images (e.g., a description of processing for changing a background image and a description of processing for changing a main image). For example, processing for changing a background image and a main image from monochrome images to color images is described.

The contents-description portion 251b is a portion in which the contents of the document to be displayed are defined in HTML. The contents-description portion 251b includes a description for designating a background image and a description for designating a main image. For example, monochrome images are designated as a background image and a main image, respectively.

When the client computer 100 acquires from the server computer 200a the HTML document 251 having the contents illustrated in FIG. 24, the browser 110 and the script-execution engine 120 operate in association with each other so as to perform processing for displaying the document. At this time, a sequence similar to the sequence of FIG. 6 is executed except for the steps S12 and S16 in FIG. 6. That is, in a step corresponding to the step S12 in FIG. 6, the contents including the images designated by the descriptions for designating a background image and a main image are displayed. In addition, in a step corresponding to the step S16 in FIG. 6, the background image designated by the description for designating a background image is changed to another image in accordance with the description of processing for changing the background image, and the main image designated by the description for designating a main image is changed to another image in accordance with the description of processing for changing the main image.

Thus, it is possible to display the screen in such a manner that the background image and the main image are specific images (e.g., monochrome images), from the time immediately after the loading of the HTML document 251 until completion of the execution of the script.

An example of the above HTML document in which JavaScript is used as a script language is indicated below.

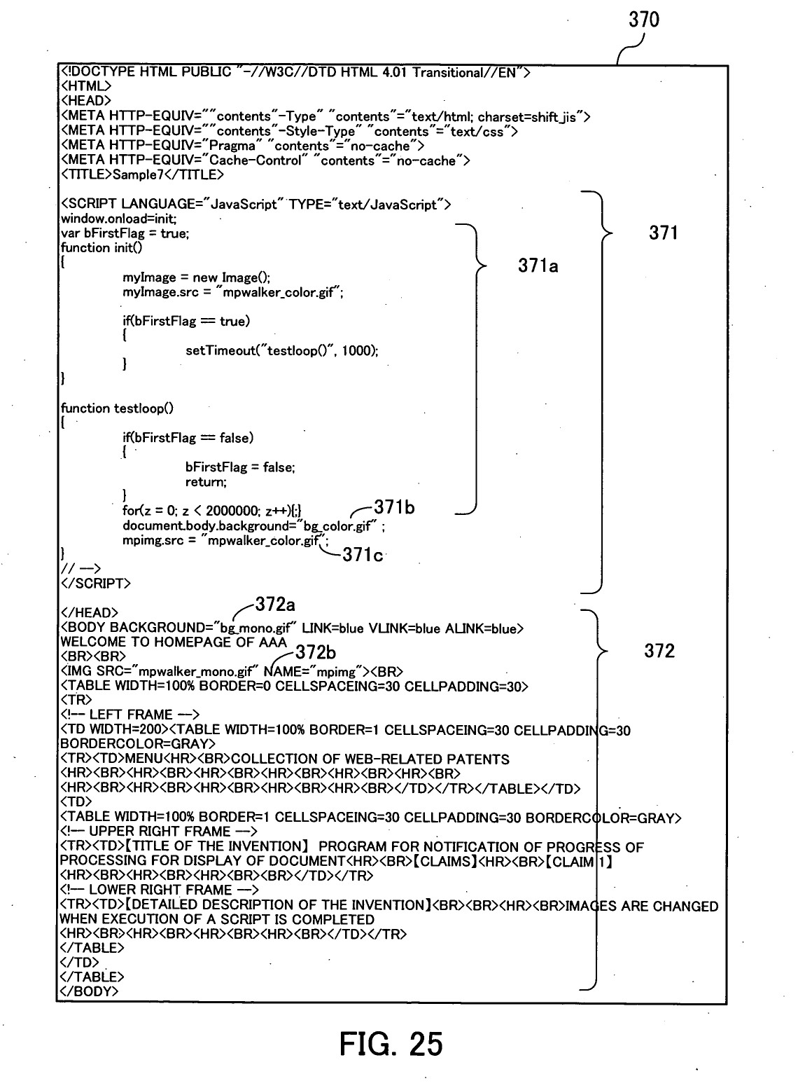

FIG. 25 is a diagram illustrating a first example of an HTML document in the case where images are changed. The HTML document 370 contains a script-description portion 371 and a contents-description portion 372.

The script-description portion 371 is a region delimited with the <SCRIPT> tag and the </SCRIPT> tag. The script-description portion 371 is a script which is executed after the contents of the HTML document 370 are displayed on the screen (i.e., a script which is executed on the occurrence of an onLoad event). The script-description portion 371 can be divided into an essential description portion 371a, a background-image-change description portion 371b, and a main-image-change description portion 371c.

The essential description portion 371a is an essential portion of the script to be executed, the background-image-change description portion 371b is a script for changing the background image. In the example of FIG. 25, at the final stage of the processing described in the script and performed on the occurrence of the onLoad event, the document.body.background property is changed to the color image (document.body.background=“bg_color.gif”). Thus, the background image is changed to a color image. The main-image-change description portion 371c is a script for changing the main image. In the example of FIG. 25, at the final stage of the processing described in the script and performed on the occurrence of the onLoad event, the mpimg.src property is changed to the color image (mpimg.src=“mpwalker_color.gif”). Thus, the main image is changed to a color image.

The contents-description portion 372 is a region delimited with the <BODY> tag and the </BODY> tag. In the contents-description portion 372, the contents to be displayed as a webpage and a manner of display are defined. The <BODY> tag contains a description 372a for designating a background image and a description 372b for designating a main image. In the description 372a for designating a background image, the value of the document.body.background property is designated to be the monochrome image (BACKGROUND=“bg_mono.gif”). In the description 372b for designating a main image, the value of the mpimg.src property is designated to be the monochrome image (IMG SRC=“mpwalker mono.gif” NAME=“mpimg”).

Therefore, when the browser 110 loads the HTML document 370 as above, first, a webpage containing a monochrome background image and a monochrome main image is displayed.

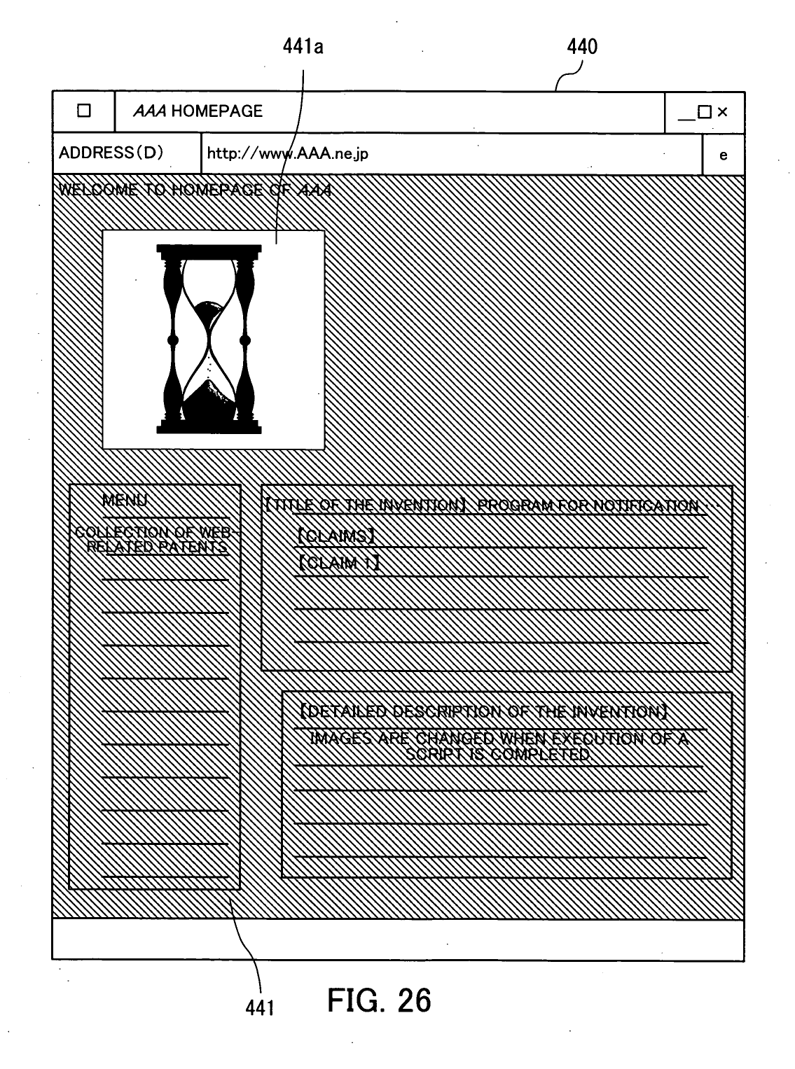

FIG. 26 is a diagram illustrating an example of display of a webpage during execution of the script in the case where images are changed. When the browser 110 loads the HTML document 370 as illustrated in FIG. 25, first, the webpage 441 is displayed in the browser screen 440. At this time, in the webpage 441, the contents described in the contents-description portion 372 in the HTML document 370 are displayed in a manner of display defined in the contents-description portion 372. That is, a monochrome background image is displayed in accordance with the description 372a for designating a background image indicated in FIG. 25, and a monochrome image 441a is displayed as a main image in accordance with the description 372b for designating a main image indicated in FIG. 25. In the example of FIG. 26, in order to clearly indicate the state in which a script is under execution, an image of a sandglass is displayed. Since the background image and the main image are monochrome images, the user can easily recognize that the execution of the script has not yet been completed.

After the operation of displaying the webpage 441 is completed, the processing for initialization in accordance with the script is started by the script-execution engine 120. During the execution of the initialization, the main image and the background image in the webpage 441 remain monochrome. At the final stage of the processing for initialization, the background image and the main image are changed to color images. Then, the processing for initialization in accordance with the script is completed.

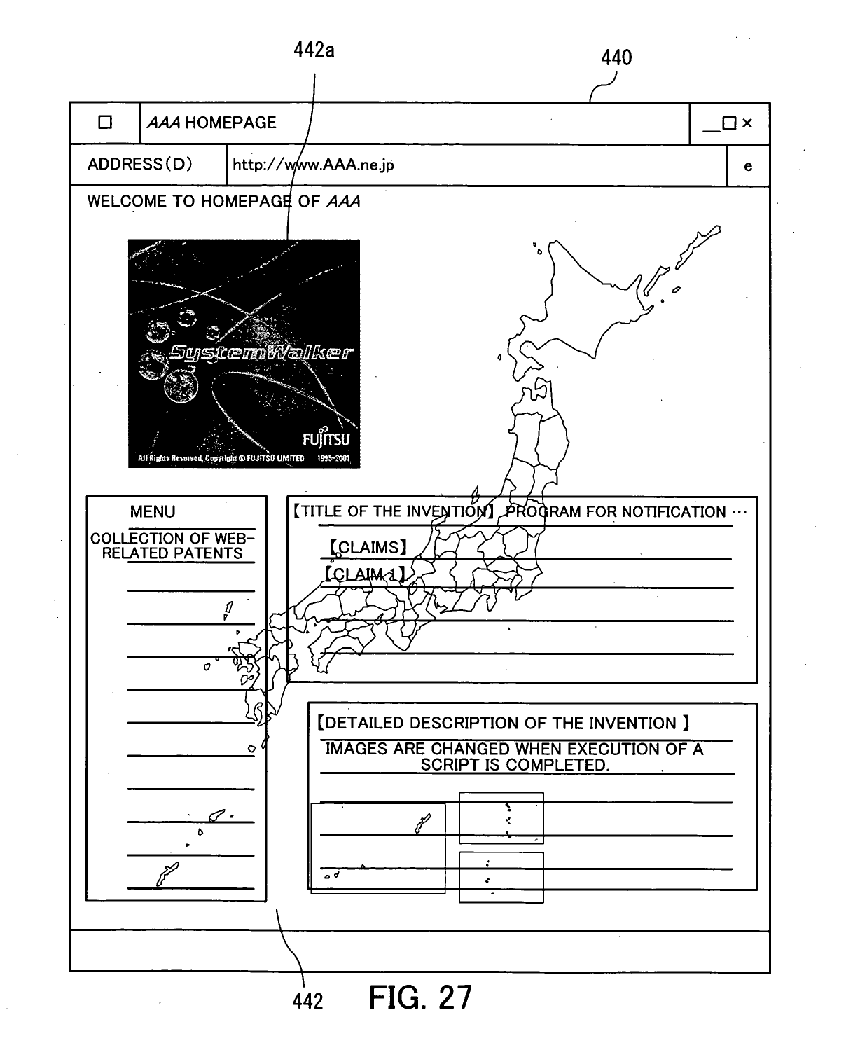

FIG. 27 is a diagram illustrating an example of display of a webpage after completion of execution of a script in the case where images are changed. After completion of execution of the script, in the webpage 442, the contents of the document are displayed over a color background image, and the main image 442a is changed to a color image.

As explained before, while a script is under execution, a monochrome image or an image which is recognized as indicating that a script is under execution is displayed. Therefore, users can easily recognize that a script is under execution.

In the examples of FIGS. 26 and 27, the monochrome image 441a and the color image 442a show different patterns in order to illustratively clarify the difference between the images. However, the monochrome image 441a, i.e., an image to be displayed during execution of a script, may be an image generated by color-to-monochrome conversion of the color image 442a.

Next, the aforementioned second way of changing an image is explained below.

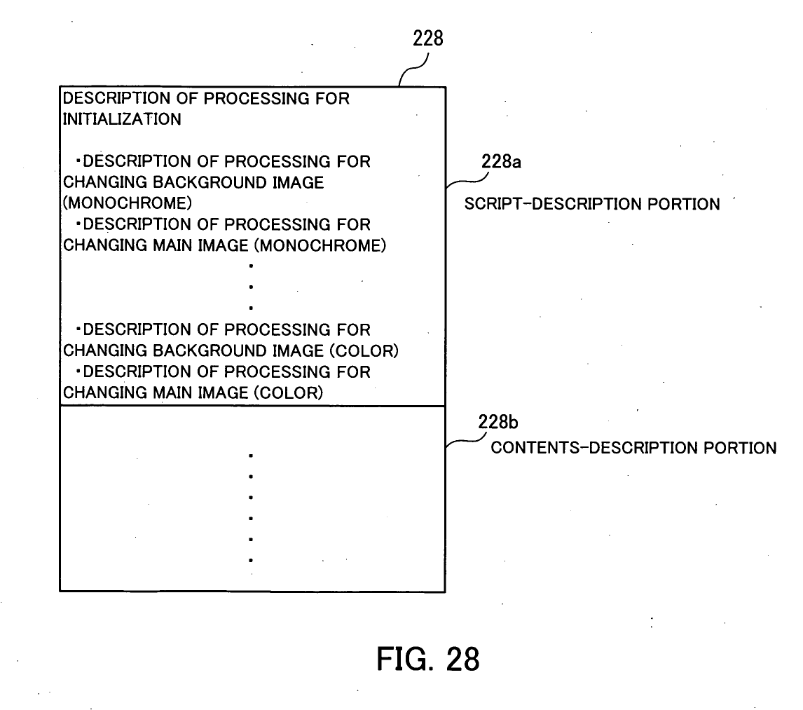

FIG. 28 is a diagram illustrating a second example of an HTML document in the case where images are changed. As illustrated in FIG. 28, the HTML document 228 can contain a script-description portion 228a and a contents-description portion 228b. The script-description portion 228a includes descriptions of processing for initialization. The descriptions of processing for initialization include descriptions of processing for changing images in each of the beginning and final stages. The descriptions of processing for changing images in the beginning stage (e.g., a description of processing for changing a background image and a description of processing for changing a main image) are descriptions of processing for changing the images so as to indicate that the script is under execution. For example, immediately after the start of the processing for the initialization, the background image is changed to monochrome, and a monochrome image is displayed as a main image. The descriptions of processing for changing images in the final stage (e.g., a description of processing for changing a background image and a description of processing for changing a main image) are descriptions of processing for changing the images so as to indicate that execution of a script is already completed. For example, immediately after the processing for the initialization is completed, the background image and the main image are respectively changed to color images.

When the client computer 100 acquires from the server computer 200a the HTML document 228 having the contents illustrated in FIG. 28, the browser 110 and the script-execution engine 120 operate in association with each other so as to perform processing for displaying the document. At this time, a sequence similar to the sequence of FIG. 11 is executed except for the steps S25 and S27 in FIG. 11. In a step corresponding to the step S25 in FIG. 11, the background image and the main image are changed in accordance with the descriptions of processing for changing images in the beginning stage. In a step corresponding to the step S27 in FIG. 11, the background image and the main image are changed in accordance with the descriptions of processing for changing images in the final stage.

Thus, it is possible to display specific images (e.g., monochrome images) on the screen from the time immediately after the loading of the HTML document 228 until completion of the execution of the script.

An example of the above HTML document in which JavaScript is used as a script language is indicated below.

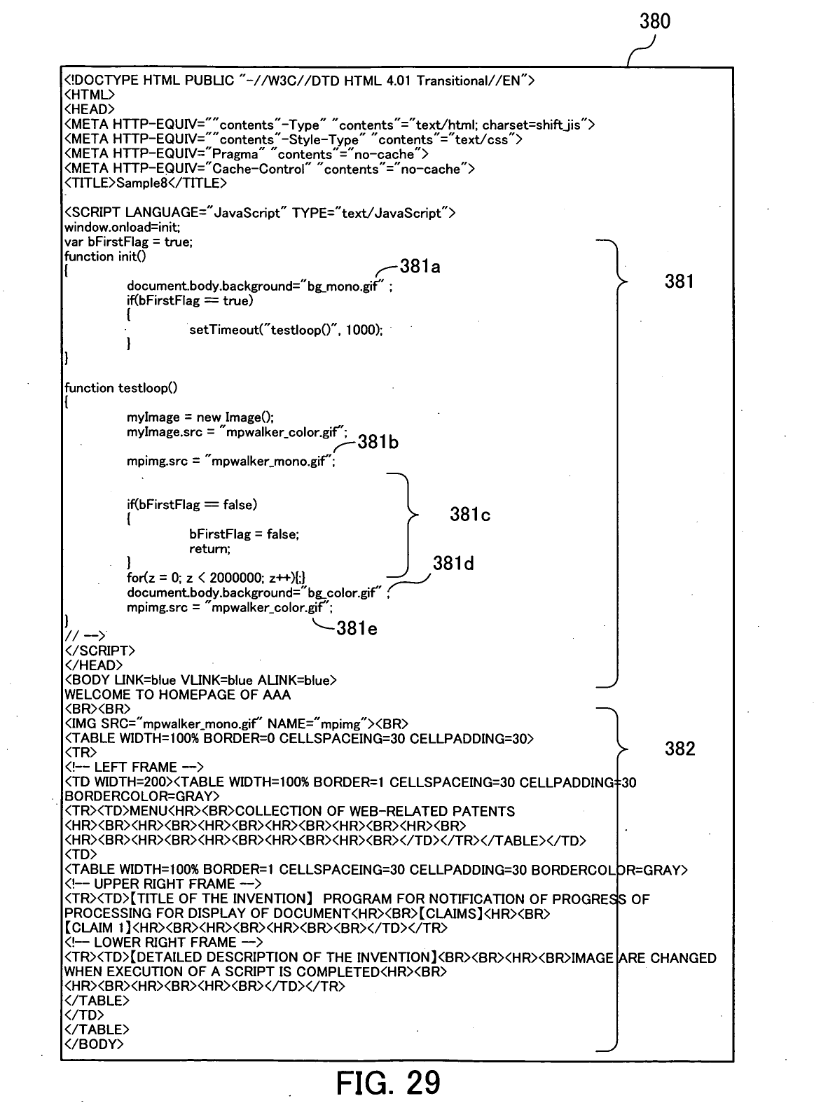

FIG. 29 is a diagram illustrating a second example of an HTML document in the case where images are changed. The HTML document 380 contains a script-description portion 381 and a contents-description portion 382.

The script-description portion 381 is a region delimited with the <SCRIPT> tag and the </SCRIPT> tag. The script-description portion 381 is a script which is executed after the contents of the HTML document 380 are displayed on the screen (i.e., a script which is executed on the occurrence of an onLoad event). The script-description portion 381 can be divided into a background-image-change description portion 381a in the beginning stage, a main-image-change description portion 381b in the beginning stage, an essential description portion 381c, a background-image-change description portion 381d in the final stage, and a main-image-change description portion 381e in the final stage.

The background-image-change description portion 381a in the beginning stage is a script for changing a background image displayed during execution of a script. In the example of FIG. 29, the document.body.background property is changed to an image file which is to be used during execution of a script (document.body.background=“bg_mono.gif”), at the beginning stage of the processing described in the script and performed on the occurrence of the onLoad event.

The main-image-change description portion 381b in the beginning stage is a script for changing a main image displayed during execution of a script. In the example of FIG. 29, the mpimg.src property is changed to an image file which is to be used during execution of a script (mpimg.src=“mpwalker mono.gif”), at the beginning stage of the processing described in the script and performed on the occurrence of the onLoad event.

The essential description portion 381c is an essential portion of the script to be executed. In the example of FIG. 29, dummy processing performed when a screen is displayed is described. In the dummy processing, a test loop is executed for a predetermined duration by making the script execution time equal to a predetermined length.

The background-image-change description portion 381d in the final stage is a script for changing a background image to an image to be displayed after execution of a script is completed. The background-image-change description portion 381d is executed after the execution of the essential description portion 381c is completed. (The background-image-change description portion 381d is described at the end of the script in the order of execution.) In the example of FIG. 29, the document.body.background property is changed to an image file which is to be used after the execution of the script is completed (document.body.background=“bg_color.gif”), at the final stage of the processing described in the script and performed on the occurrence of the onLoad event.

The main-image-change description portion 381e in the final stage is a script for changing a main image to an image to be displayed after execution of a script is completed. The main-image-change description portion 381e is executed after the execution of the essential description portion 381c is completed. (The main-image-change description portion 381e is described at the end of the script in the order of execution.) In the example of FIG. 29, the mpimg.src property is changed to an image file which is to be used after the execution of the script is completed (mpimg.src=“mpwalker_color.gif”), at the final stage of the processing described in the script and performed on the occurrence of the onLoad event.

The contents-description portion 382 is a region delimited with the <BODY> tag and the </BODY> tag. In the contents-description portion 382, the contents to be displayed as a webpage and a manner of display are defined.

Therefore, when the browser 110 loads the HTML document 380 as above, immediately after the start of the initialization in accordance with the script, the background image and the main image are respectively changed to images represented by image files which are to be used during execution of the script. Thereafter, when the execution of the initialization in accordance with the script is completed, the background image and the main image are respectively changed to images represented by image files which are to be used after the execution of the script is completed. At this time, the screen is displayed, for example, as illustrated in FIGS. 26 and 27.

According to the embodiment explained above, it is possible to concurrently display on a screen the contents of an HTML document and the progress of execution of a script. At this time, the contents of the documents are not hidden behind an indication of the progress of execution of the script. In addition, since the indication of the progress of execution of the script is displayed at a conspicuous position on the browser screen, it is possible to notify a user of the state in which a script is under execution, with high reliability.

Further, since control is automatically returned to the browser when the execution of the script is completed, it is unnecessary to make a manipulation input, for example, by clicking on a button. Therefore, operability in browsing a document is improved.

Furthermore, since the progress of execution of the script is indicated by the manner of display of the entire screen (such as the background color or the text color), the state in which a script is under execution is very clear to users. Therefore, it is possible to prevent erroneous operations by the users.

As well as the HTML tags and the properties (e.g., document.fg.Color and document.bg.Color) in JavaScript, style sheets and other script languages can be used for changing the manner of display when execution of a script is completed.

In addition, the manner of display can be changed by changing one or more of the background color, the text color, and a background image (or a main image).

Further, although, in the above explanations, a manner of display during execution of a script and a manner of display after the execution of the script are defined in an HTML document, the manners of display may be defined in the client computers 100, 100a, . . . . For example, the manner of display during execution of a script can be defined in settings for the browser 110. In this case, a webpage is displayed in a predefined manner of display during execution of a script. For example, the background is displayed in gray. Thereafter, when the execution of the script is completed, the webpage is displayed in a manner of display defined in the HTML document.

In addition, although the script language in the above explanations is JavaScript, similar processing can be performed even when other script languages are used. For example, Visual Basic Script or other script languages developed by Microsoft Corporation can be used. In this case, the manner of display is changed when processing for initialization of a page in accordance with a script described in Visual Basic Script or other script languages is completed.

The above processing functions can be realized by a server computer and a client computer. In this case, a server program and a client program are provided, where the server program describes details of processing realizing the functions which the server computer should have, and the client program describes details of processing realizing the functions which the client computer should have. When a server computer executes the above server program, the processing functions of a web server or the like are realized on the server computer. In addition, when a client computer executes the above client program, the processing functions of the browser and the script-execution engine are realized on the client computer.

Each of the server program and the client program describing the details of processing can be stored in a computer-readable recording medium. The computer-readable recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the server program and the client program into the market, for example, it is possible to sell a portable recording medium such as a DVD or a CD-ROM in which each program is recorded. Alternatively, the client program can be stored in a storage device belonging to a server computer, and transferred from the server computer to the client computer through a network.

The server computer which executes the server program stores the server program in a storage device belonging to the server computer. For example, the server program is initially recorded in a portable recording medium. Then, the server computer reads the server program from the storage device, and performs processing in accordance with the server program. Alternatively, the server computer may directly read the server program from the portable recording medium for performing processing in accordance with the server program.

The client computer which executes the client program stores the client program in a storage device belonging to the client computer. For example, the client program is initially recorded in a portable recording medium, or transferred from a server computer. Then, the client computer reads the client program from the storage device, and performs processing in accordance with the client program. Alternatively, the client computer may directly read the client program from the portable recording medium for performing processing in accordance with the client program. Further, the client computer may sequentially perform processing in accordance with each portion of the client program when the client computer receives the portion of the client program from the server computer.

As explained above, according to the present invention, while processing in accordance with a description of the processing is executed, the contents of a document are displayed in the first manner of display. Therefore, the user can browse the contents of the document without waiting for completion of the processing in accordance with the description of the processing. In addition, since the manner of display is the first manner of display, the user can easily recognize that the processing in accordance with the description of the processing is under execution. Therefore, it is possible to prevent erroneous operations during execution of the processing in accordance with the description of the processing.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A document display apparatus for displaying on a screen a document which contains a description of processing, characterized in comprising:
document display means which displays contents of the document in a first manner of display when the document is inputted;
processing execution means which executes processing in accordance with the description of processing contained in the document when the contents of the document is displayed by the document display means; and
manner-of-display change means which changes a manner of display of the contents of the document to a second manner of display when execution of the processing by the processing execution means in accordance with the description of processing is completed.

2. The document display apparatus according to claim 1, wherein said manner-of-display change means changes a background color.

3. The document display apparatus according to claim 1, wherein said manner-of-display change means changes a text color.

4. The document display apparatus according to claim 1, wherein said manner-of-display change means changes a background color and a text color.

5. The document display apparatus according to claim 1, wherein said manner-of-display change means changes a displayed image to another image.

6. The document display apparatus according to claim 1, wherein said document display means displays at least a portion of the contents of said document in monochrome, and said manner-of-display change means changes monochrome display of said portion to color display.

7. The document display apparatus according to claim 1, wherein said document display means determines said first manner of display based on designation of a manner of display which is described in said document.

8. The document display apparatus according to claim 1, wherein said manner-of-display change means changes the manner of display of the contents of said document in accordance with a description of processing for changing the manner of display, which is included as a description of processing at a final stage in said description of processing contained in the document.

9. A document-embedded type program which is described in a document, and is characterized in making a computer perform a processing sequence which comprises:
a step of displaying contents of the document in a first manner of display when the document is inputted;
a step of executing processing in accordance with a description of essential processing contained in the document, after the step of displaying the contents is executed; and
a step of changing a manner of display of the contents of the document to a second manner of display in accordance with a description of processing for changing the manner of display, which is contained in said document, when execution of the processing in accordance with the description of essential processing is completed.

10. The document-embedded type program according to claim 9, wherein background colors in said first and second manners of display are different.

11. The document-embedded type program according to claim 9, wherein at least a portion of the contents of said document is displayed in monochrome in said first manner of display, and in color in said second manner of display.

12. A document display method for displaying on a screen a document containing a description of processing, characterized in comprising:
a step of displaying contents of the document in a first manner of display when the document is inputted;
a step of executing processing in accordance with the description of processing contained in the document when the contents of the document is displayed; and
a step of changing a manner of display of the contents of the document to a second manner of display when execution of the processing in accordance with the description of processing is completed.

13. The document display method according to claim 12, wherein background colors in said first and second manners of display are different.

14. The document display method according to claim 12, wherein at least a portion of the contents of said document is displayed in monochrome in said first manner of display, and in color in said second manner of display.

15. A computer-readable recording medium storing a document-embedded type program which is described in a document, and is characterized in making a computer perform a processing sequence which comprises:
a step of displaying contents of the document in a first manner of display when the document is inputted;
a step of executing processing in accordance with a description of essential processing contained in the document, after the step of displaying the contents is executed; and
a step of changing a manner of display of the contents of the document to a second manner of display in accordance with a description of processing for changing the manner of display, which is contained in said document, when execution of the processing in accordance with the description of essential processing is completed.
